(19) United States
(12) Patent Application Publication
(10) Pub. No.: US 2002/0010824 A1
(43) Pub. Date: Jan. 24, 2002

(54) Electronic equipment and method for processing digital serial data at bus initialization phase in interface unit

(76) Inventors: Sumihiro Okawa, Kanagawa (JP); Kiyoshi Miura, Kanagawa (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/827,841

(22) Filed: Apr. 5, 2001

(30) Foreign Application Priority Data
Apr. 7, 2000 (JP) P2000-107065

(51) Int. Cl. G06F 13/00; G06F 13/38

(52) U.S. Cl. 710/129

(57) ABSTRACT

In the bus initialization phase, the state is transferred to the reset start state (i.e., R1 state) first, and a bus reset signal is sent to all the connected partners for a predetermined period of time determined by the reset_time (ranging from 1.26 ƒÊm at the shortest to 1.40 ƒÊm at the longest). When it is acknowledged that bus reset signals have been received from all the connected partners and a predetermined period of time has elapsed, the state is transferred to the reset wait state (R1 state). In this arrangement, there is no fear that an IDLE signal received in a reset wait state from a partner connected by use of a long cable will result in an erroneous transfer to a tree identification phase, and the bus reset signal will be received from the connected partner at the tree identification phase so as to return again to the R0 state at the bus initialization phase.

### CROSS-REFERENCE TO RELATED APPLICATIONS

This application claims priority from Japanese Application No. P2000-107065 filed Apr. 7, 2000, the disclosure of which is hereby incorporated by reference herein.

### BACKGROUND OF THE INVENTION

The present invention relates to electronic equipment provided with an interface unit for digital serial data constituting a physical layer which conforms to the IEEE 1394 standard, and a processing method at a bus initialization phase in the interface unit. More specifically, the present invention relates to electronic equipment or the like which sends a bus reset signal in the reset start state to all the receivers for a specified period of time at a bus initialization phase, and when a specified period of time has elapsed and the equipment acknowledges that it has received bus reset signals from all the connected partners, conducts the transition of its state to a reset wait state, thereby enabling the short bus reset to operate normally even in the case where the electronic equipment is connected to the partners by use of a long cable.

As the standard defining the interface for supporting high-speed data transmission and real-time transmission as the interface for multimedia data transmission, the IEEE 1394 high-performance serial bus standard (IEEE 1394 standard) is known. The IEEE 1394 standard defines data transmission at rates of 100 Mbps (98.304 Mbps), 200 Mbps (196.608 Mbps), and 400 Mbps (393.216 Mbps), and defines a 1394 port with a higher transmission rate to have compatibility with its lower transmission rate. This standard allows data transmission at rates of 100 Mbps, 200 Mbps, and 400 Mbps in one and the same network.

In addition, the IEEE 1394 standard employs a transmission format in the Data/Strobe link (DS-Link) coding method. In the transmission format in the Data/Strobe link coding method, as shown in FIG. 1, transmission data is converted into two signals including data and strobe for compensating the signal thereof, and the exclusive OR of these two signals is obtained, thereby generating clocks. The IEEE 1394 standard also defines a cable 200 having a structure such as shown in the cross-sectional view of FIG. 2, including: first shielding layers 201; two pairs of twisted pair lines (i.e., signal lines) 202, each shielded by a first shielding layer 201; power supply lines 203; and a second shielding layer 204 which entirely covers the cable constituted by tying the first shielding layers 201, the twisted pair lines 202, and the power supply lines 203 together.

The IEEE 1394 standard performs arbitration for obtaining a bus prior to data transmission, and, as a control signal for arbitration, defines an arbitration signal. In addition, the IEEE 1394 standard automatically reconfigures the entire bus topology by resetting the bus at the time when a node is added to or deleted from the bus. The arbitration signal is also defined as a control signal required for the topology reconfiguration.

The arbitration signal has three logical values of “1”, “0”, and “Z” which are generated in accordance with the rules shown in Tables 1 and 2 below, and are decoded in accordance with the rules shown in Table 3 below.

TABLE 1

| Transmit | | | |
|---|---|---|---|
| arbitration | | | |
| signal A | Drivers | | |
| (Arb_A_Tx) | Strb_Tx | Strb_Enable | Comments |
| Z | — | 0 | TPA driver is |
| | | | disabled |
| 0 | 0 | 1 | TPA driver is |
| | | | enabled, |
| | | | strobe is low |
| 1 | 1 | 1 | TPA driver is |
| | | | enabled, |
| | | | strobe is high |

TABLE 2

| Transmit | | | |
|---|---|---|---|
| arbitration | | | |
| signal B | Drivers | | |
| (Arb_B_Tx) | Data_Tx | Data-Enable | Comments |
| Z | — | 0 | TPB driver is |
| | | | disabled |
| 0 | 0 | 1 | TPB driver is |
| | | | enabled, data |
| | | | is low |
| 1 | 1 | 1 | TPB driver is |
| | | | enabled, data |
| | | | is high |

TABLE 3

| Received | Transmitted | | |
|---|---|---|---|
| arbitration | arbitration | Interpreted | |
| comparator | signal for | arbitration | |
| value | this port | signal | |
| (Arb_n^{a}_Rx) | (Arb_n^{a}_TX) | (Arb_n^{a}) | Comments |
| Z | Z | Z | If this port is |
| 0 | Z | 0 | transmitting a |
| 1 | Z | 1 | Z, then the |
| | | | received signal |
| | | | will be the same |
| | | | as transmitted |
| | | | by the port on |
| | | | the other end of |
| | | | the cable. |
| Z | 0 | 1 | If the |
| | | | comparator is |
| | | | receiving a Z |
| | | | while this port |
| | | | is sending a 0, |
| | | | then the other |
| | | | port must be |
| | | | sending a 1. |
| | | | This is the |
| | | | first half of |
| | | | the l's |
| | | | dominance rule. |
| 0 | 0 | 0 | The other port |
| | | | is sending a 0 |
| | | | or a Z. |
| Z | 1 | 1 | The other port |
| | | | must be sending |
| | | | a 0. This is |
| | | | the other half |
| | | | of the 1's |
| | | | dominance rule. |
| 1 | 1 | 1 | The other port |
| | | | is sending a 1 |
| | | | or a Z. |

^{a}“n” is “A” or “B”.
This table applies to both signal pairs.

In addition, the line state is encoded by two transmission arbitration signals Arb_A_Tx and Arb_B_Tx in accordance with the rules shown in Table 4 below, and the line state is encoded by receive arbitration signals Arb_A and Arb_B in accordance with the rules shown in Table 5 below.

TABLE 4

| Arbitration transmit | | | |
|---|---|---|---|
| (Arb_A_ | | Line state | |
| Tx) | (Arb_B_Tx) | name | Comments |
| Z | Z | IDLE | sent to indicate |
| | | | a gap |
| Z | 0 | TX_REQUEST | sent to parent |
| | | | to request the |
| | | | bus |
| | | TX_GRANT | sent to child |
| | | | when bus is |
| | | | granted |
| 0 | Z | TX_PARENT_NOTIFY | sent to parent |
| | | | candidate |
| | | | during |
| | | | tree-ID |
| 0 | 1 | TX_DATA_PREFIX | sent before any |
| | | | packet data and |
| | | | between blocks |
| | | | of packet data |
| | | | in the case of |
| | | | concatenated |
| | | | subactions |
| | | | sent to child to |
| 1 | Z | TX_CHILD_{—} | acknowledge |
| | | NOTIFY | the |
| | | | parent notify |
| | | TX_IDENT_{—} | sent to parent |
| | | DONE | to indicate that |
| | | | self-TD is |
| | | | complete |
| 1 | 0 | TX_DATA_END | sent at the end |
| | | | of packet |
| | | | transmission |
| 1 | 1 | BUS_RESET | sent to force a |
| | | | bus |
| | | | reconfiguration |

TABLE 5

| Interpreted arbitration | | | |
|---|---|---|---|
| signals | | | |
| (Arb_A) | (Arb_B) | Line state name | Comments |
| Z | Z | IDLE | the attached peer |
| | | | PHY is inactive |
| Z | 0 | RX_PARENT_NOTIFY | the attached peer |
| | | | PRY wants to |
| | | | be a child |
| | | RX_REQUEST_CANCEL | attached |
| | | | peer PRY |
| | | | has abandoned a |
| | | | request (this PHY |
| | | | is sending a |
| | | | grant) |
| Z | 1 | RX_IDENT_DONE | the child PHY has |
| | | | completed its |
| | | | self-ID |
| 0 | Z | RX_SELF_ID_GRANT | the parent PRY is |
| | | | granting the bus |
| | | | for a self-ID |
| | | RX_REQUEST | a child PHY is |
| | | | requesting the |
| | | | bus |
| 0 | 0 | RX_ROOT_{—} | the attached peer |
| | | CONTENTION | PHY and this |
| | | | PHY |
| | | | both want to be |
| | | | child |
| | | RX_GRANT | the parent PHY is |
| | | | granting control |
| | | | of the bus |
| 0 | 1 | RX_PARENT_{—} | attached peer |
| | | HANDSHAKE | PHY |
| | | | acknowledges |
| | | | parent notify |
| | | RX_DATA_END | the attached peer |
| | | | PHY has finished |
| | | | sending a block |
| | | | of data is about |
| | | | to release the |
| | | | bus |
| 1 | Z | RX_CHILD_HANDSHAKE | attached peer |
| | | | PRY |
| | | | acknowledges |
| | | | TX_CHILD_{—} |
| | | | NOTIFY |
| | | | (the peer PHY is |
| | | | a child of this |
| | | | PHY) |
| 1 | 0 | RX_DATA_PREFIX | the attached per |
| | | | PHY is about to |
| | | | send packet data |
| | | | or has finished |
| | | | sending a block |
| | | | of packet data |
| | | | and is about to |
| | | | send more |
| 1 | 1 | BUS_RESET | send to force a |
| | | | bus |
| | | | reconfiguration |

By use of the arbitration signals described above, the topology is automatically configured through the bus initialization phase, tree identification phase, and self-identification phase in this order.

At the bus initialization phase, the bus reset signal changes all the nodes into particular states, to entirely clear the topology information. As a result of the bus initialization, each node has information only about whether the node itself is a branch (i.e., whether it is directly connected to a plurality of nodes adjacent thereto), whether the node is a leaf (i.e., whether it is connected to only a single node adjacent thereto), and whether the node is independent (i.e., whether it is connected to no nodes adjacent thereto). FIG. 3A is a diagram showing a network constituted by leaf nodes and branch nodes.

At the tree identification phase, the entire network topology is converted into one tree in which one of the nodes thereof is designated as a root. Each port for connection in each node is assigned a label which is referred to as a “parent” port (in the case where the port is connected to a node closer to the root), or a “child” port (in the case where the port is connected to a node more remote from the root). A port which is not connected to any of the nodes is assigned with a label “off ”, and does not participate in the arbitration process conducted afterwards. FIG. 3B shows the network constituted at the completion of the tree identification process.

At the self-identification phase, each node is provided with an opportunity to select its own specific physical_ID to identify itself with respect to an arbitrary control element associated with the bus. This process is also necessary to control electric power of low level, and to produce a topology map of the system required for determining the rate of each data path.

The self-identification process employs a theoretic decision selection process. Specifically, a root node leaves the media control to the node associated with the connection port having the smallest number, and waits until the node sends an “ident_done” signal for notifying that the node itself and all the child nodes thereof have completed self-identification. After that, the root node leaves the control to the node associated with the connection port having the next larger number, and waits until the processing of the node has been completed. When the nodes associated with all the ports of the root have completed their processings, the root itself conducts self-identification. The child nodes conduct the same process as above, respectively. The completion of the self-identification process is acknowledged when the bus goes into an idle state over a subaction gap period.

Each node can send its self-identification information by sending a very short packet involving physical_ID or other control information to all of the four networks. The physical_ID is a value obtained by simply counting the number of times the node receives self-identification information from the other nodes before it sends its self-identification packet. For example, the node which sends its self-identification packet first selects a 0 as a physical_ID, and the node which sends its self-identification packet second selects a 1 as a physical_ID. The same process is repeated to determine the physical_ID of each node. FIG. 3C shows the network obtained after the completion of the self-identification process. As seen in FIG. 3C, each “child” port is assigned with a “ch-i” label by which the node connected to the port can be identified.

FIG. 4 is a transition diagram of the bus initialization phase which consists of two states, namely, the R0 (i.e., Reset Start) state and the R1 (i.e., Reset Wait) state. The following description of the operation of the short bus reset will be made for a network in which, as shown in FIG. 5, nodes a, b, and c are connected, the cable between nodes a and b is 100 m in length, and the cable between nodes b and c is 3 m in length.

In the normal bus reset, a node outputs a bus reset signal to the bus unconditionally, and keeps the bus reset signal in an output state for a period of 166 ƒÊs. In contrast, in the short bus reset, a node conducts bus arbitration to obtain the right to use the bus, and after that, outputs a bus reset signal to the bus. The node keeps the bus reset signal in an output state for a period ranging from 1.26 ƒÊs to 1.40 ƒÊs. The short bus reset process described above is suggested in “P1394a Draft 5.0 Feb. 11, 2000”.

As described above, in the short bus reset, a node outputs the bus reset signal to the bus after the right to use the bus has been obtained, and therefore, all the other nodes can recognize the bus reset in a short period of time. As a result, the bus reset signal is kept in an output state for only a short period of time as described above, and the bus initialization process can be conducted rapidly.

Next, referring to FIG. 6, the operation of the short bus reset will be described in the network consisting of the nodes a, b, and c shown in FIG. 5. FIG. 6 shows the operation of nodes a, b, and c in a simplified manner in accordance with the passage of time.

In the event that short bus reset occurs in node b, node b transfers its state to the R0 state in accordance with the transition drawing of FIG. 4, and sends a bus reset signal to nodes a and c for a predetermined period of time (ranging from 1.26 ƒÊs at the shortest to 1.40 ƒÊs at the longest: Steps 1 and 2 in FIG. 6). Upon receiving the bus reset signal from node b, each of nodes a and c itself also starts to send a bus reset signal (Steps 3 and 4 in FIG. 6).

Then, node b transfers its state to the R1 state and waits until it receives an IDLE signal or a PARENT_NOTIFY signal from nodes a and c while it keeps on sending an IDLE signal to nodes a and c (Steps 5 and 6 in FIG. 6). If node b does not receive the IDLE signal or the PARENT_NOTIFY signal from nodes a or c before the predetermined period of time (ranging from 1.40 ƒÊs at the shortest to 1.5 ƒÊ at the longest) has elapsed, node b returns its state to R0.

In the network shown in FIG. 5, since the cable between nodes b and c is 3 m in length, the delay in signal transmission therebetween is as small as 15 ns. This structure allows node c to send the IDLE signal or the PARENT_NOTIFY signal to node b within a predetermined period of time (Step 7 in FIG. 6).

In contrast, the cable between nodes a and b is 100 m in length, and the delay in signal transmission therebetween is as long as about 500 ns. The first bus reset signal from node b reaches node a after a lapse of about 500 ns (Step 1 in FIG. 6), and after another lapse of about 500 ns, the bus reset signal reaches node b from node a (Step 3 in FIG. 6). As a result, a time of 1 ƒÊs or longer will elapse since node b does not start bus reset signal transmission until the bus reset signal is returned from node a. In actuality, since node a needs time for signal processing, there may arise a case where node b cannot receive the bus reset signal from node a, even if node b completes bus reset signal transmission and transfers its state to the R1 state.

In such a case, node b receives the IDLE signal from node a when node b is in the R1 state, and node b erroneously transfers its state from the R1 state to the tree identification phase. In the tree identification phase, node b receives the bus reset signal from node a (Step 3 in FIG. 6), and returns to the R0 state at the bus initialization phase where node b is in the normal bus reset state. As a result, when the nodes are connected to each other by a long cable, it is impossible to conduct a normal short bus reset operation.

### SUMMARY OF THE INVENTION

It is an object of the present invention to provide electronic equipment or the like in which a normal short bus reset operation can be conducted even when a long cable is used therein.

In an aspect of the present invention, electronic equipment includes a bus; an interface unit for digital serial data connected to the bus, the interface unit having a physical layer in conformity with the IEEE 1394 standard; at least one partner connected to the bus, each connected partner having a physical layer which conforms to the IEEE 1394 standard; and a processor connected to the interface unit. The interface unit includes: a transmitter for transmitting an arbitration signal to each connected partner, and a receiver for receiving an arbitration signal from each connected partner. In a bus initialization phase, a bus reset signal is sent to each connected partner for a predetermined period of time in a reset start state of the interface unit, and when it is acknowledged that bus reset signals have been received from each connected partner and a specified period of time has elapsed, the interface unit is transferred to a reset wait state.

Another aspect of the present invention provides a method for bus initialization in an interface unit for digital serial data having a physical layer in conformity with the IEEE 1394 standard, the interface unit being connected by a bus to at least one partner having a physical layer which conforms to the IEEE 1394 standard. According to the method, a bus reset signal is transmitted to each connected partner for a predetermined period of time in a reset start state of the interface unit, and the state of the interface unit is transferred to a reset wait state when it is acknowledged that bus reset signals have been received from each connected partner and a specified period of time has elapsed.

In the present invention, in the bus initialization phase, the bus reset signal is sent to each connected partner for a predetermined period of time in the reset start state (i.e., R1 state). When the predetermined time has elapsed and also it is acknowledged that bus reset signals have been received from each connected partner, the interface unit is transferred to a reset wait state (i.e., R1 state). In this case, the bus reset signal is received from each connected partner for a predetermined period of time or after the predetermined period of time has elapsed, depending on the length of the cable which is used for connection with the connected partners. When the bus reset signals are received from all of the connected partners within a predetermined period of time, the interface unit is transferred to the reset wait state immediately after the predetermined period of time has elapsed.

As in the manner described above, the transition to the reset wait state occurs after it is acknowledged that the bus reset signals have been received from all of the connected partners. This structure avoids such a problem that an IDLE signal is received in the reset wait state from a partner connected by a long cable, for example, to cause erroneous transition of the state into the tree identification phase, and the bus reset signal is received from this connected partner after the transition to the tree identification phase has been completed and the state has been returned to the reset wait state (i.e., R0 state) in the bus initialization phase. In this manner, it is possible to allow a short bus reset to operate normally even when a long cable is used for connection with the connected partners.

### BRIEF DESCRIPTION OF THE DRAWINGS

FIG. 1 is a diagram showing a structure of transmission data which conforms to the IEEE 1394 standard;

FIG. 2 is a cross-sectional view of a cable defined by the IEEE 1394 standard;

FIGS. 3A to 3C are diagrams showing the network constituted at the completion of bus initialization, tree identification, and self-identification;

FIG. 4 is a transition diagram of the bus initialization phase;

FIG. 5 is a block diagram showing an exemplary structure of the network;

FIG. 6 is a diagram for illustrating an exemplary operation of a short bus reset;

FIG. 7 is a block diagram showing an exemplary structure of the network constructed in accordance with the IEEE 1394 standard;

FIG. 8 is a diagram showing constituent elements and the protocol architecture of the interface which conforms to the IEEE 1394 standard;

FIG. 9 is a diagram showing an asynchronous packet;

FIGS. 10A and 10B are diagrams for illustrating arbitration;

FIG. 11 is a diagram showing a packet in isochronous transmission;

FIG. 12 is a diagram showing addressing in the CSR architecture;

FIG. 13 is an explanatory diagram showing examples of positions, names, and operations of the main CSRs;

FIG. 14 is an explanatory diagram showing an example of a general ROM format;

FIG. 15 is an explanatory diagram showing an example of a bus info block, a root directory, and a unit directory;

FIG. 16 is an explanatory diagram showing an example of the structure of PCRs;

FIGS. 17A to 17D are explanatory diagrams showing examples of the structures of an OMPR, an OPCR, an iMPR, and an iPCR, respectively;

FIG. 18 is an explanatory diagram showing an exemplary relationship between a plug, a plug control register, and a transmission channel;

FIG. 19 is an explanatory diagram showing an example of a data structure by a hierarchical structure of descriptors;

FIG. 20 is an explanatory diagram showing an example of a data format of descriptors;

FIG. 21 is an explanatory diagram showing an example of the generation ID of FIG. 20;

FIG. 22 is an explanatory diagram showing an example of the list ID of FIG. 20;

FIG. 23 is an explanatory diagram showing a relationship between the command and the response of FCP;

FIG. 24 is an explanatory diagram showing the relationship between the command and the response of FIG. 23 in more detail;

FIG. 25 is an explanatory diagram showing an exemplary data structure of an AV/C command;

FIGS. 26A to 26C are explanatory diagrams showing specific examples of the AV/C command;

FIGS. 27A and 27B are explanatory diagrams showing specific examples of the command and the response of the AV/C command;

FIG. 28 is a block diagram showing an exemplary structure of a physical layer;

FIG. 29 is a transition drawing of a bus initialization phase; and

FIG. 30 is a diagram for illustrating an exemplary operation of short bus reset.

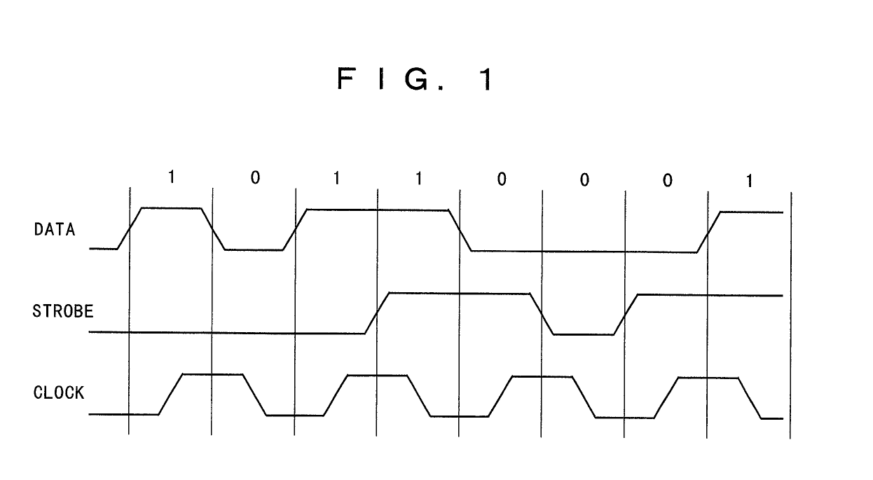

### DETAILED DESCRIPTION OF THE PREFERRED EMBODIMENTS

Hereinafter, embodiments of the present invention will be described in detail with reference to the drawings.

FIG. 7 is a diagram showing an exemplary structure of a network constituted based on the IEEE 1394 standard. A work station 10, a personal computer 11, a hard disc drive 12, a CD-ROM drive 13, a camera 14, a printer 15, and a scanner 16 together constitute an IEEE 1394 node, and are connected to each other via IEEE 1394 buses 20. There are two methods for connecting equipment in conformity with the IEEE 1394 standard: a daisy chain connection and a node multipoint connection. In the daisy chain connection method, a maximum of 16 nodes (i.e., equipment having an IEEE 1394 port) can be connected. A combination of the daisy chain connection method and the node multipoint connection method, as shown in FIG. 7, allows 63 nodes to be connected, which is the maximum number in the IEEE 1394 standard.

The IEEE 1394 standard allows cable connection/disconnection in the operating state of the equipment, that is, when the equipment is turned on. At the time when the node is added or deleted, the reconfiguration of the topology is conducted through the bus initialization phase, the tree identification phase, and the self-identification phase in this order, as described above. The identification and arrangement of the nodes connected to the network is controlled on the interface.

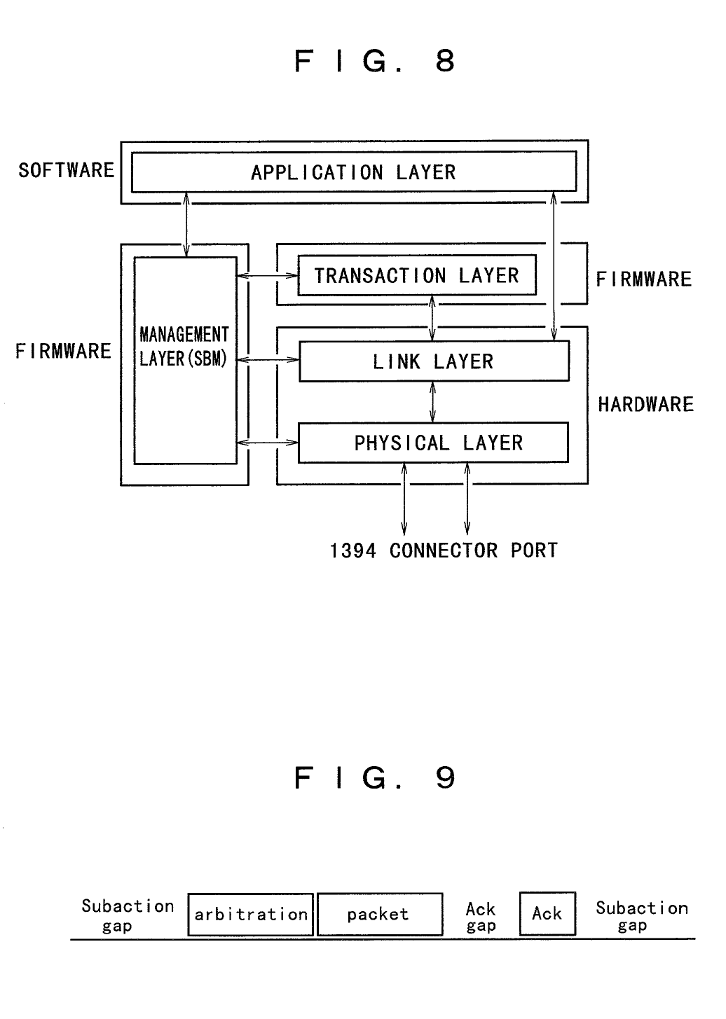

FIG. 8 is a diagram showing the constituent elements and the protocol architecture of the interface which conforms to the IEEE 1394 standard. The interface consists of both hardware and firmware.

The hardware consists of a physical layer (PHY) and a link layer. The physical layer directly drives a signal which conforms to the IEEE 1394 standard. The link layer includes a host interface and a physical layer interface.

The firmware consists of a transaction layer and a management layer. The transaction layer includes a management driver for performing an actual operation for the interface which conforms to the IEEE 1394 standard. The management layer includes a driver for managing a network, and is referred to as a serial bus management (SBM) and conforms to the IEEE 1394 standard. An application layer consists of software used by a user, and management software for interfacing the transaction layer and the management layer.

In the IEEE 1394 standard, transmission operations performed within the network are referred to as subactions, and the following two subactions are defined. One of the subactions is in a non-synchronous transmission mode referred to as an “asynchronous” mode, while the other is in a real-time transmission mode referred to as an “isochronous” mode in which the transmission band is secured. Each of the subactions is further categorized in three parts which assume the following states, respectively:

an arbitration state;

a packet transmission state; and

an acknowledgement state,

wherein the acknowledgement state is omitted from the “isochronous” mode.

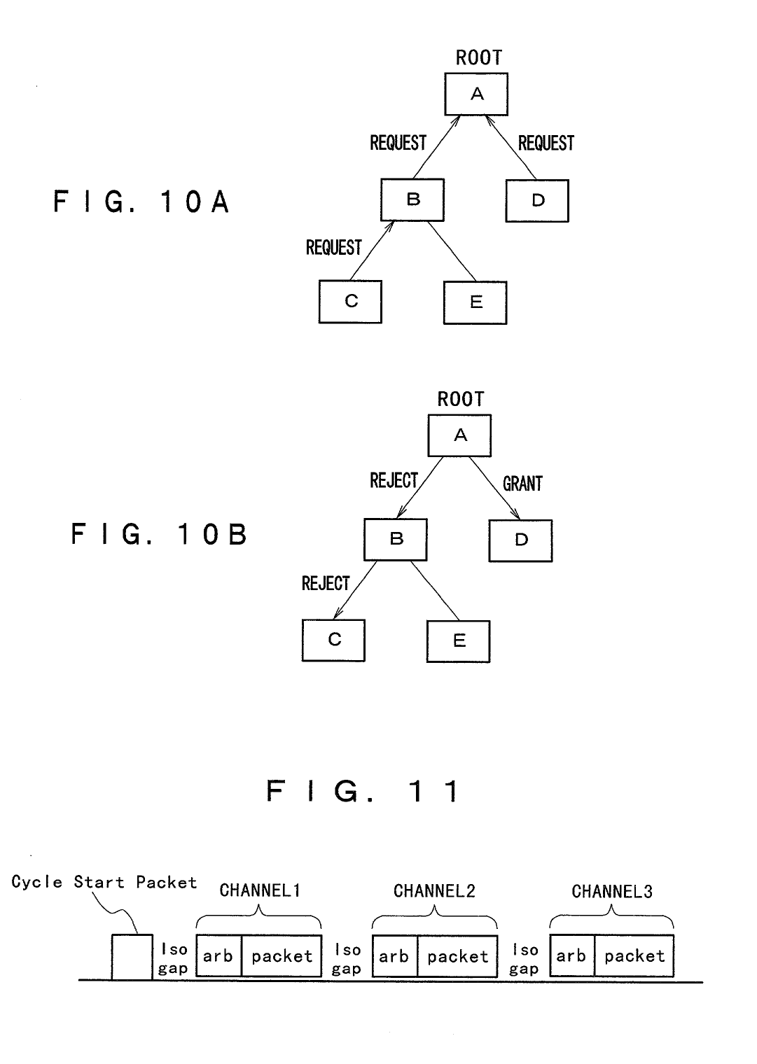

In the subaction in the asynchronous mode, non-synchronous transmission is conducted. FIG. 9 is a diagram showing the transaction state with the lapse of time in the asynchronous transmission mode. In FIG. 9, the initial subaction gap indicates that the bus is in the idle state. The time during which the subaction gap lasts is monitored to judge whether or not the immediately preceding transmission has finished and another new transmission is possible.

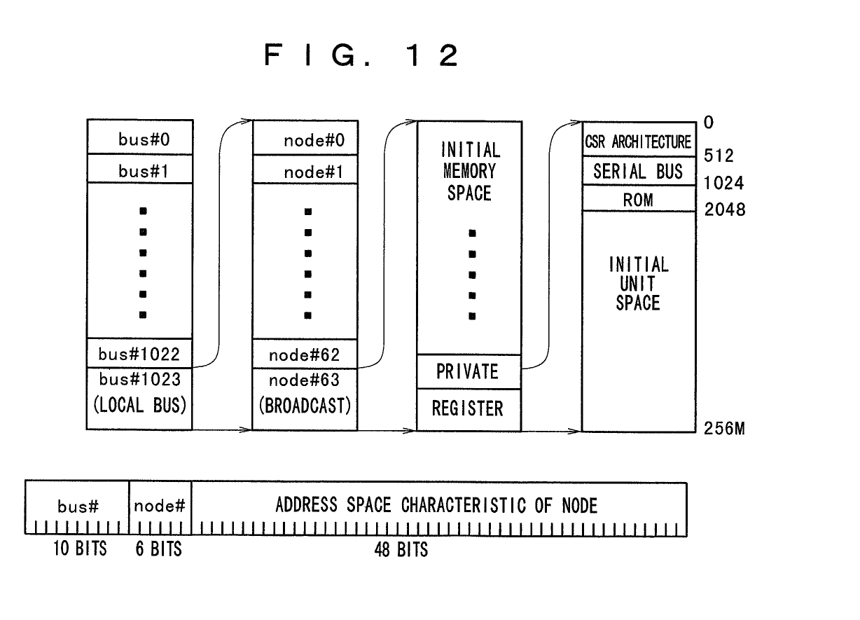

If the idle state lasts for a specified period of time or longer, the node which wishes to conduct transmission judges that the bus is usable, and performs an arbitration for obtaining the bus. In an actual operation, the judgment whether or not to stop the bus is conducted by the node A located at the root, as shown in FIGS. 10A and 10B. After the node wishing the transmission obtains the right to use the bus in this arbitration, the node conducts transmission of the next data, that is, packet transmission. After the data transmission, the node which has received the data conducts acknowledgement in response to the data transmission by returning a data receipt acknowledgement return code (ack). The sending of the data receipt acknowledgement return code (ack) acknowledges that the transmission has been conducted normally in both the transmission node and the receiving node. After that, the state is returned to the subaction gap, that is, to the bus idle state, and the transmission operation as described above is repeated.

In the subaction in the isochronous mode, transmission is executed basically in the same manner as in the asynchronous mode, except that, as shown in FIG. 11, transmission in the isochronous subaction is assigned a higher priority and is executed prior to transmission in the asynchronous subaction. The isochronous transmission in the isochronous subaction is executed subsequent to the cycle start packet which is issued at about every 8 kHz (125 ƒÊs), and is assigned a higher priority to be executed prior to the asynchronous transmission in the asynchronous subaction. In this manner, the isochronous transmission is in a transmission mode in which the transmission band is secured, thereby attaining the transmission of real-time data.

The cycle described above is created by a cycle start packet supplied from a node having a cycle master function (i.e., any equipment connected to the bus). In isochronous transmission, the band required for data transmission (although this is a unit of time, it is referred to as a band) is secured from the first portion of the cycle. Therefore, in isochronous transmission, data transmission within a fixed time is assured. However, since isochronous transmission has no arrangement for data protection, the data is lost when transmission errors occur. On the other hand, in asynchronous transmission, the node sends the asynchronous packet when it has obtained the right to use the bus as a result of arbitration during the time when the bus is not used for isochronous transmission in each cycle. Reliable transmission is possible by using acknowledgement and retry; however, the transmission is not executed within a fixed time.

In the case where a plurality of nodes execute real-time data transmission through isochronous transmission, the transmission data is provided with a channel ID for identifying its content (i.e., transmission node), so that only required real-time data is received.

In order to allow a predetermined node to execute isochronous transmission, it is required that the node has an isochronous function. In addition, at least one of the nodes having an isochronous function must also have a cycle master function. Furthermore, at least one of the nodes connected to the IEEE 1394 serial bus must have an isochronous resource managing function.

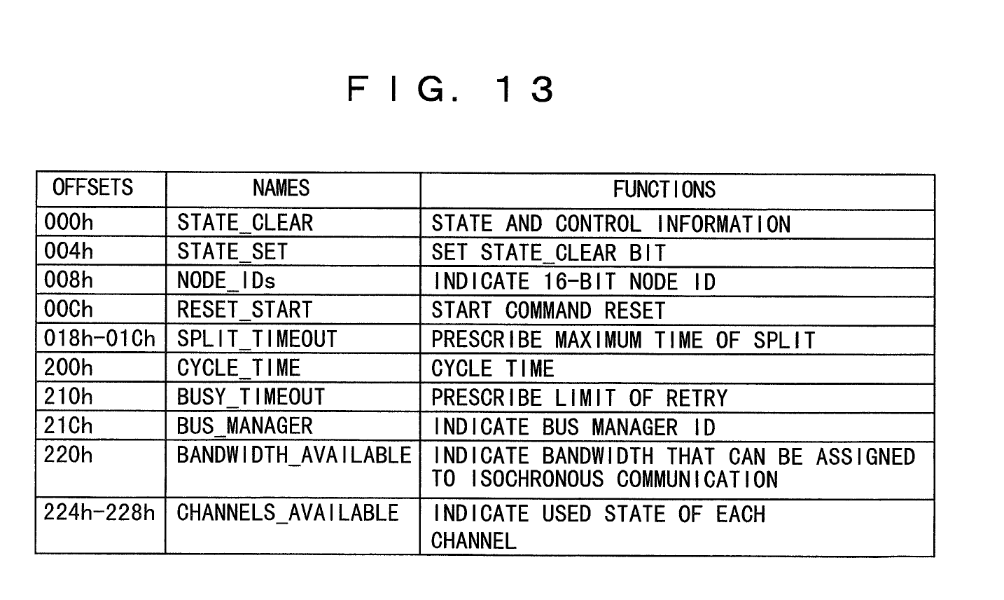

The address space defined in the IEEE 1394 standard has a structure such as shown in FIG. 12. This structure conforms to the CSR (Control & Status Register) architecture defined by the ISO/IEC13213 standard for 64-bit fixed addressing (hereinafter referred to as a “CSR architecture”). As shown in FIG. 12, the first 16 bits in each address are node IDs indicating the nodes in the respective IEEE 1394 bus, and the remaining 48 bits are used to specify address spaces given to the node. The node ID designates the bus ID by its first 10 bits, and designates the physical ID (i.e., a node ID in a narrow sense) by its next 6 bits. The bus ID and the physical ID use the value obtained when all bits are set to 1 for a special purpose. Therefore, this addressing method enables 1023 buses and 63 nodes to be specified.

In the remaining 48 bits of the address space defining 256 terabytes, the space defined by the first 20 bits is divided into an initial register space which is used for a register unique to a CSR of 2048 bytes and a register unique to the IEEE 1394 standard, a private space, and an initial memory space. The space defined by the remaining 28 bits is used, when the space defined by the first 20 bits is an initial register space, as a configuration read only memory (ROM), an initial unit space for a use specific to the node, plug control registers (PCRs), or the like.

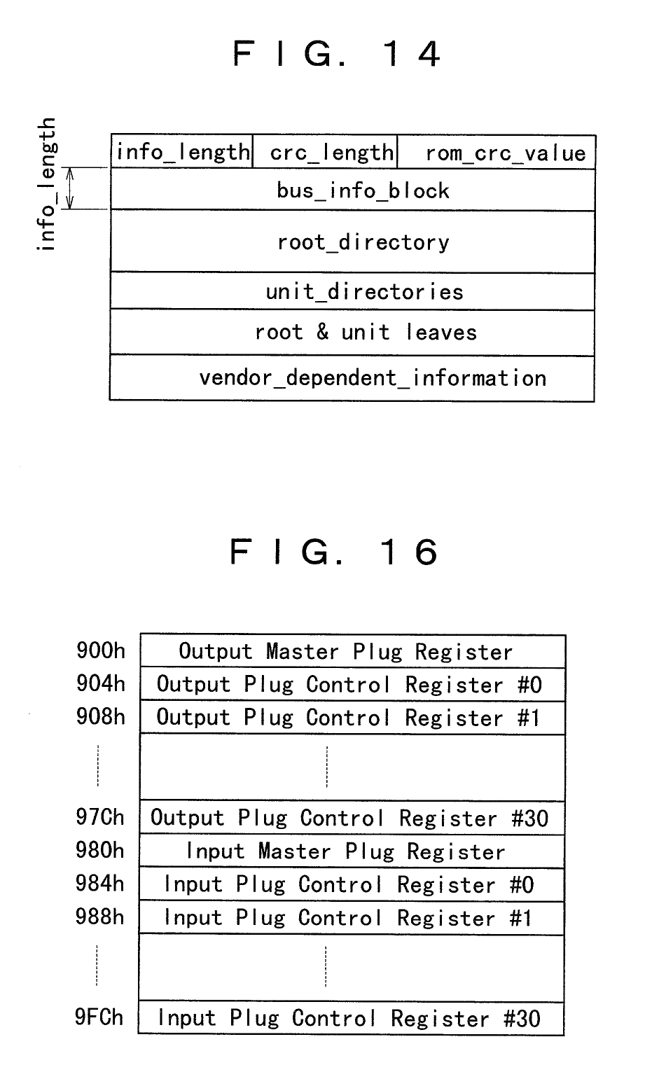

FIG. 13 is a diagram explaining offset addresses, names, and functions of major CSRs. The term “offset” in FIG. 13 shows the offset address relative to the FFFFF0000000h address (the h at the rearmost end indicates that the address is in a hexadecimal notation) at which the initial register space begins. The bandwidth available register having an offset of 220h indicates a bandwidth which can be allocated to isochronous transmission, and recognizes only the value of the node operating as an isochronous resource manager to be effective. Specifically, while each node has a CSR architecture such as shown in FIG. 12, the bandwidth available register in only the isochronous resource manager is recognized to be effective. In other words, it is only the isochronous resource manager that actually has the bandwidth available register. In the bandwidth available register, a maximum value is stored when no bandwidth has been allocated to isochronous transmission, and the value thereof is reduced every time a bandwidth is allocated to isochronous transmission.

The channels available registers from offset 224h to 228h correspond to channel numbers with 0 to 63 bits, respectively. A channel number with 0 bits means that the channel has already been allocated to the channels available register. The channels available register is effective only in the node operating as an isochronous resource manager.

Referring again to FIG. 12, a configuration read only memory (ROM) based on a general read only memory (ROM) format is arranged in the addresses 200h to 400h within the initial unit space. FIG. 14 is a diagram for illustrating the general ROM format. The node, which is a unit of access on the IEEE 1394 bus, can hold a plurality of units capable of operating independently while having a common address space in the node. The unit directories field can indicate the version and the position of the software for the unit. The bus info block and the root directory are located at fixed positions, and the other blocks are located at positions designated by the offset addresses.

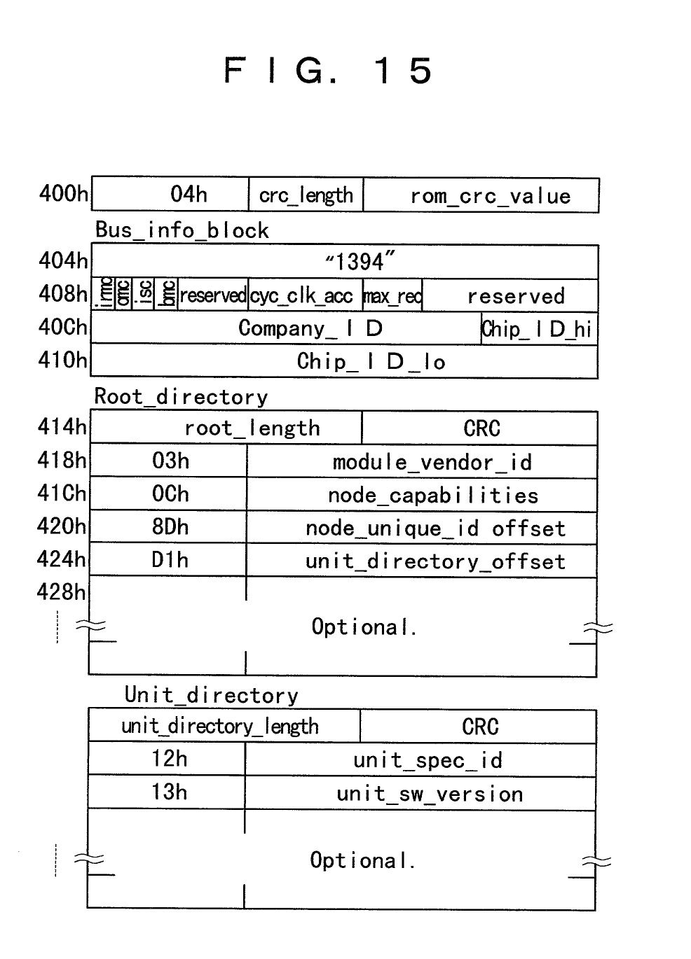

FIG. 15 is a diagram showing the bus info block, root directory, and unit directory in detail. An ID number indicating the manufacturer of the apparatus is stored in the Company ID field in the bus info block. An ID which is unique to that apparatus and which is the only one ID in the world which does not overlap other IDs is stored in the Chip ID field. 00h is written into the first octet of the unit spec ID field of the unit directory of apparatus satisfying the requirements of the IEC 61883 standard, Aoh is written into the second octet thereof, and 2Dh is written into the third octet thereof. Furthermore, 01h is written into the first octet of the unit switch version field, and 1 is written into the least significant bit (LSB) of the third octet.

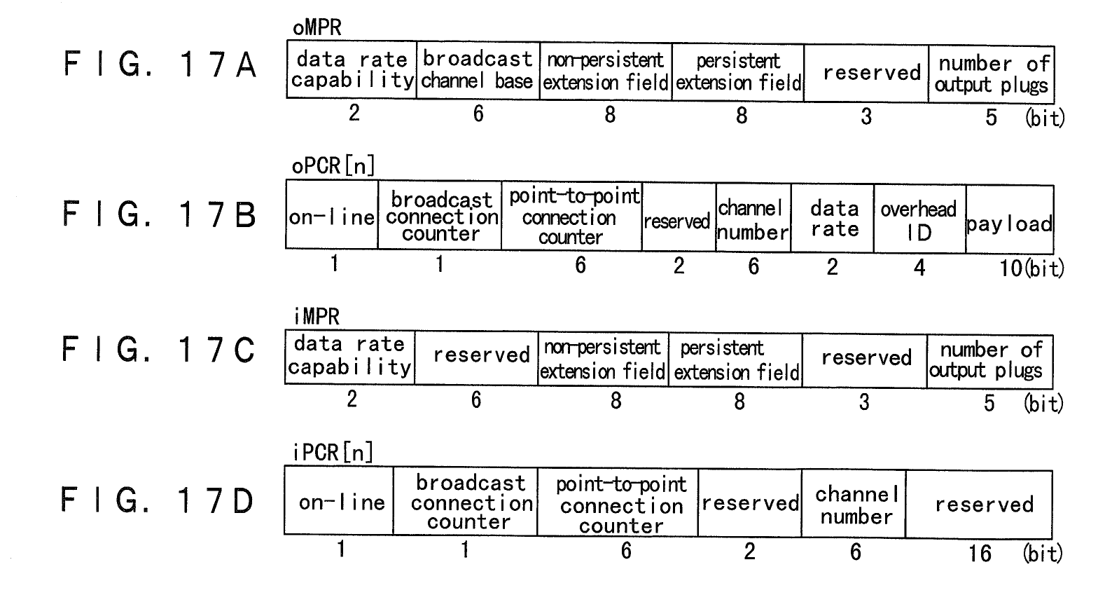

The node has a plug control register (PCR) defined by the IEC 61883 standard in the addresses 900h to 9FFh within the initial unit space shown in FIG. 12, in order to control input/output of an apparatus via an interface. This design embodies the concept of a plug substantiated to form a signal path logically similar to an analog interface. FIG. 16 is a diagram for illustrating the structure of a PCR. The PCR has an output plug control register (OPCR) indicating an output plug and an input plug control register (IPCR) indicating an input plug. The PCR also has an output master plug register (OMPR) and an input master plug register (iMPR) for indicating information on an output plug or an input plug specific to each apparatus. While each apparatus does not have a plurality of oMPRs and iMPRs, it is possible to have a plurality of oPCRs or iPCRs corresponding to individual plugs depending on the ability of the apparatus. Each of the PCRs shown in FIG. 16 has 31 oPCRs and 31 iPCRs, respectively. The isochronous data flow is controlled by manipulating the registers corresponding to these plugs.

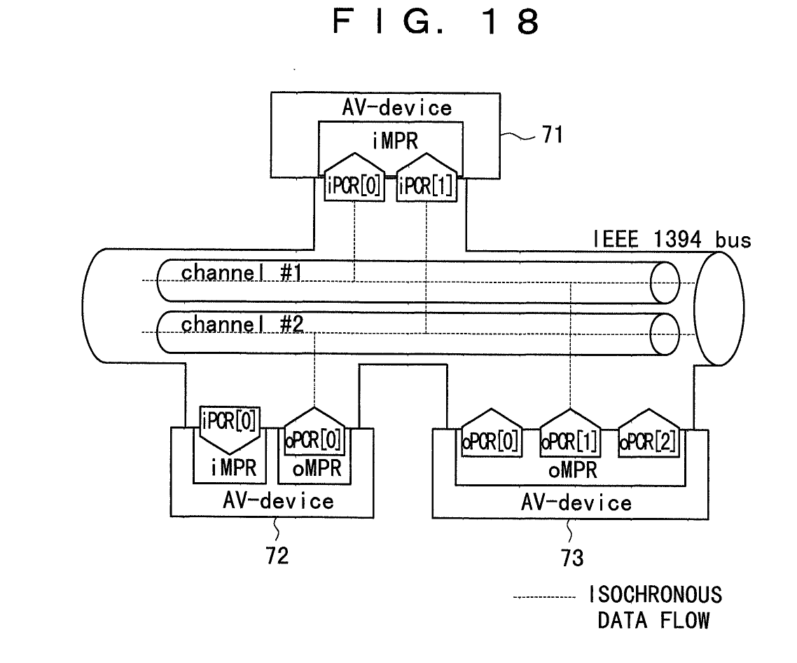

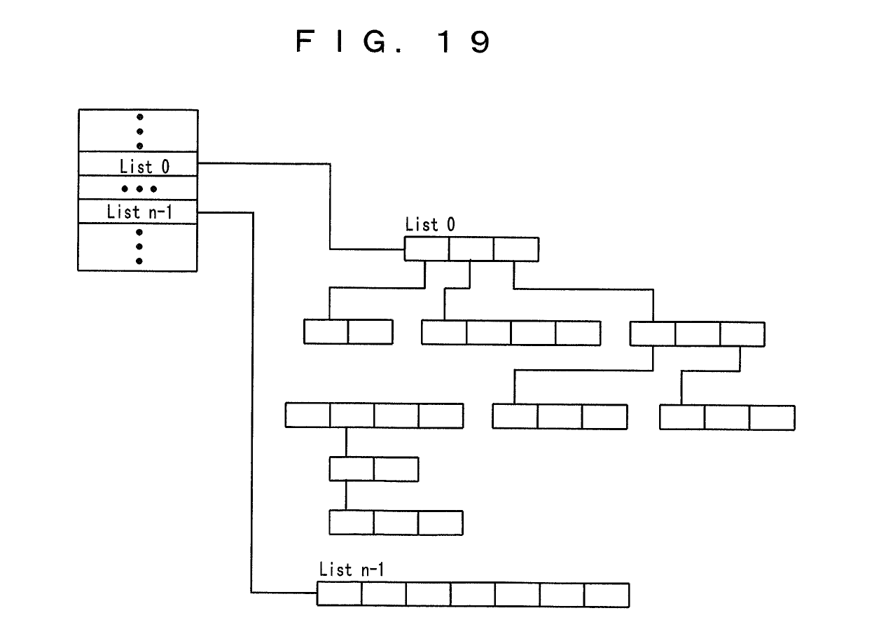

FIGS. 17A to 17D are diagrams showing the structures of an OMPR, OPCR, iMPR, and iPCR, respectively. FIG. 17A shows the structure of an OMPR, FIG. 17B shows the structure of an OPCR, FIG. 17C shows the structure of an iMPR, and FIG. 17D shows the structure of an iPCR. A code indicating the maximum transmission rate of isochronous data which the apparatus can send or receive is stored in the 2 bit data rate capability field on the MSB side of the OMPR and iMPR. A broadcast channel base field in the OMPR defines the channel number to be used for broadcast output.

The number of output plugs that the apparatus has, that is, a value showing the number of oPCRs, is stored in the 5 bit number of output plugs field on the LSB side of the oMPR. The number of input plugs that the apparatus has, that is, a value showing the number of iPCRs, is stored in the 5 bit number of input plugs field on the LSB side of the iMPR. A non-persistent extension field and a persistent extension field are domains defined for future expansion.

An on-line field on the MSB side of both the oPCR and the iPCR indicates a state of use of a plug. Specifically, a value of 1 in the on-line field means that the plug is in an on-line state, and a value of 0 in the on-line field means that the plug is in an off-line state. The values in the broadcast connection counter fields of both the oPCR and iPCR indicate the presence (a value of 1) or absence (a value of 0) of a broadcast connection. The values in the 6 bit point-to-point connection counter fields in both the OPCR and iPCR indicate the number of point-to-point connections that the plug has.

The values in the 6 bit channel number fields in both the OPCR and iPCR indicate the isochronous channel number to which the plug is to be connected. The value in the 2 bit data rate field in the OPCR indicates an actual transmission rate of the packets of isochronous data to be output from the plug. The code stored in the 4 bit overhead ID field in the OPCR shows the bandwidth over the isochronous communication. The value in the 10 bit payload field in the OPCR indicates the maximum value of the data contained in the isochronous packets that can be handled by the plug.

FIG. 18 is a diagram showing the relationship among a plug, a plug control register, and an isochronous channel. AV devices 71 to 73 are connected to each other by an IEEE 1394 serial bus. The OMPR in the AV device 73 defines the number and transmission rate of the oPCR[0] to oPCR[2] in the device. The isochronous data for which the channel is designated by the OPCR [1] is sent to channel #1 in the IEEE 1394 serial bus. The iMPR in the AV device 71 defines the number and transmission rate of the iPCR[0] and iPCR[1] therein. The AV device 71 reads the isochronous data sent to channel #1 in the IEEE 1394 serial bus as designated by iPCR[0]. Similarly, the AV device 72 sends isochronous data to channel #2 as designated by oPCR[0]. The AV device 71 reads the isochronous data from channel #2 as designated by iPCR[1].

In the aforementioned manner, data transmission is executed among the devices connected to each other by the IEEE 1394 serial bus. In this structure, each device can be controlled and the state thereof can be determined by use of an AV/C command set defined as commands for controlling the devices connected to each other by the IEEE 1394 serial bus. Hereinafter, the AV/C command set will be described.

First, a data structure of the subunit identifier descriptor in the AV/C command set will be described with reference to FIGS. 19 to 22. FIG. 19 is a diagram showing the data structure of the subunit identifier descriptor. As seen in FIG. 19, the data structure of the subunit identifier descriptor consists of hierarchical lists. In the case of a tuner, for example, a list represents channels through which data can be received, and, in the case of a disc, for example, a list represents music recorded thereon. The uppermost list in the hierarchy is referred to as a root list, and list 0 is a root for the lists at lower positions, for example. Similarly, the lists 2 to (n−1) are also root lists. There are as many root lists as there are objects. The term “object” means, in the case where the AV device is a tuner, each channel in a digital broadcast. All the lists in one layer share the same information.

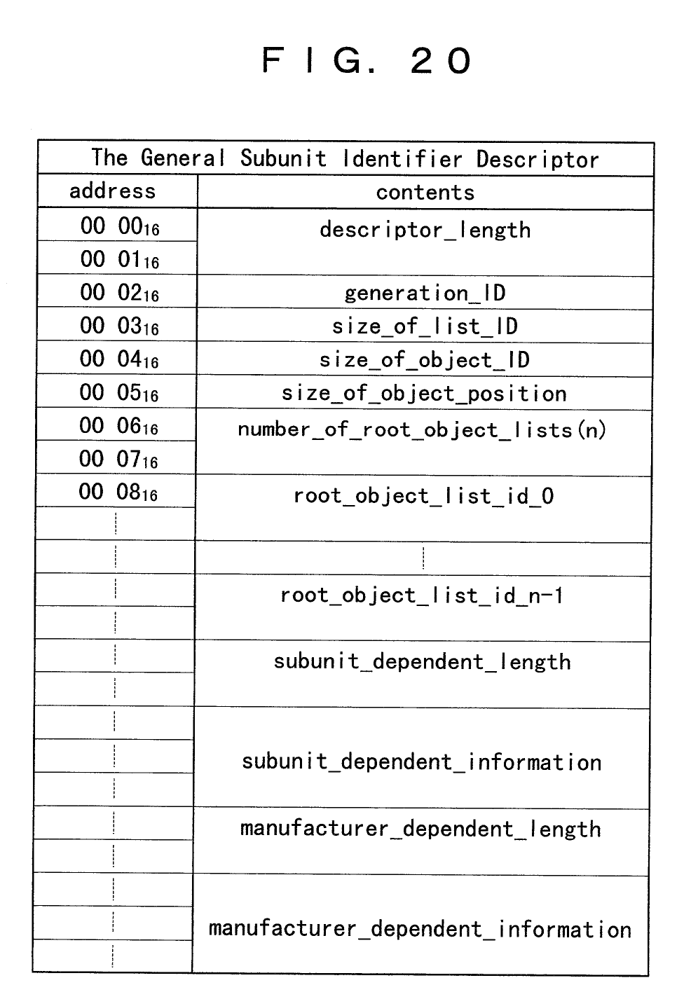

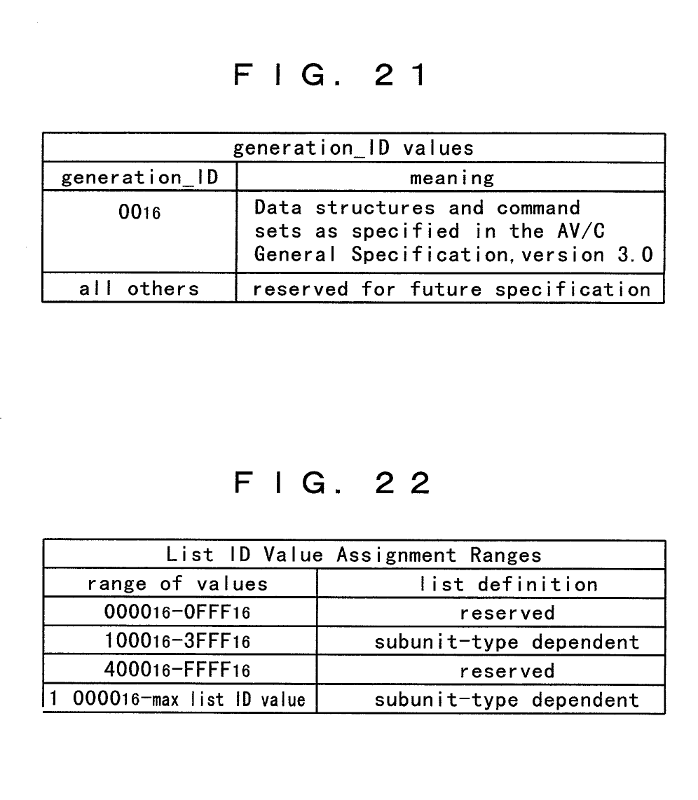

FIG. 20 is a diagram showing a format of the general subunit identifier descriptor. The subunit identifier descriptor has contents including attribute information as to functions. It does not include a value of the descriptor length field itself. The generation ID field indicates the AV/C command set version, and its value is at “00h” (the h designates that this value is in hexadecimal notation) at present, as shown in FIG. 21. A value at “00h” means that the data structure and command set are version 3.0 of AV/C general specification. In addition, as shown in FIG. 21, all the values except for “00h” are reserved for future specification.

The size of list ID field shows the number of bytes of the list ID. The size of object ID field shows the number of bytes of the object ID. The size of object position field shows the position (i.e., the number of bytes) in the lists to be referenced in a control operation. The number of root object lists field shows the number of root object lists. The root object list id field shows an ID for identifying the uppermost root object list in the independent layers in the hierarchy.

The subunit dependent length field indicates the number of bytes in a subsequent subunit dependent information field. The subunit dependent information field shows information specific to the functions. The manufacturer dependent length field shows the number of bytes in the subsequent manufacturer dependent information field. The manufacturer dependent information field shows specification information of a vender (i.e., manufacturer). When the descriptor has no manufacturer dependent information, the manufacturer dependent information field does not exist.

FIG. 22 is a diagram showing the assignment ranges of the list Ids shown in FIG. 20. As shown in FIG. 22, the values at “0000h to 0FFFh” and “4000n to FFFFh” are reserved for future specification. The values at “1000h to 3FFFh” and “10000h to max list ID value” are prepared for identifying dependent information about function type.

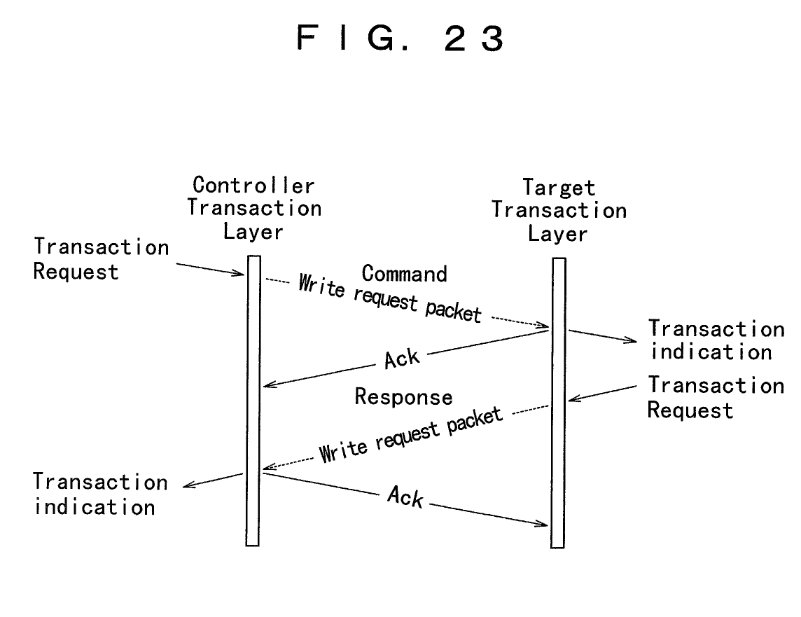

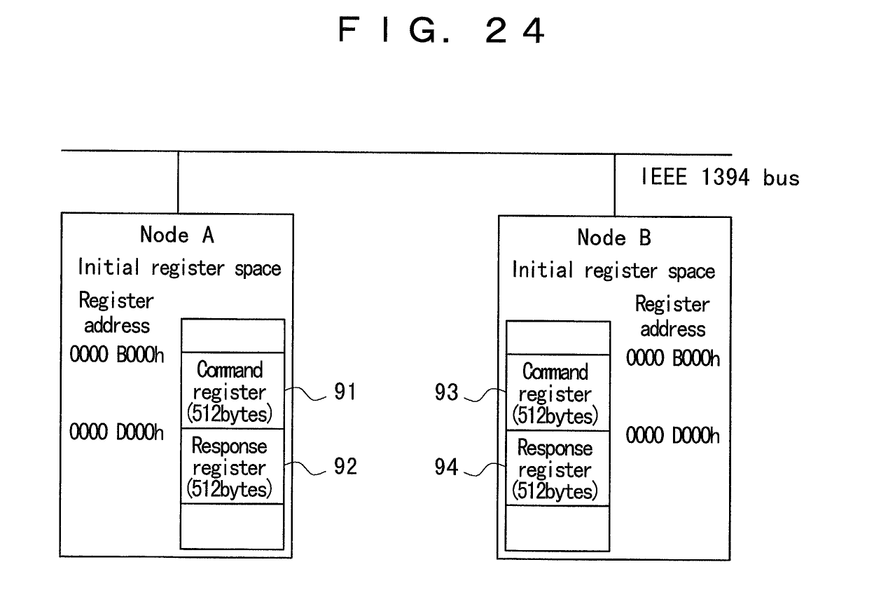

Next, the AV/C command set will be described with reference to FIGS. 23 to 27. FIG. 23 is a diagram for illustrating the command and the response of the function control protocol (FCP) of FIG. 24. The FCP is a protocol for controlling the AV device in conformity with the IEEE 1394 standard. As shown in FIG. 23, a controller is a control side, and a target is a side to be controlled. In the FCP, a command is transmitted and received between nodes by use of the write transaction in the IEEE 1394 asynchronous transmission. Upon receiving data from the controller, the target returns an acknowledgement to the controller to confirm receipt.

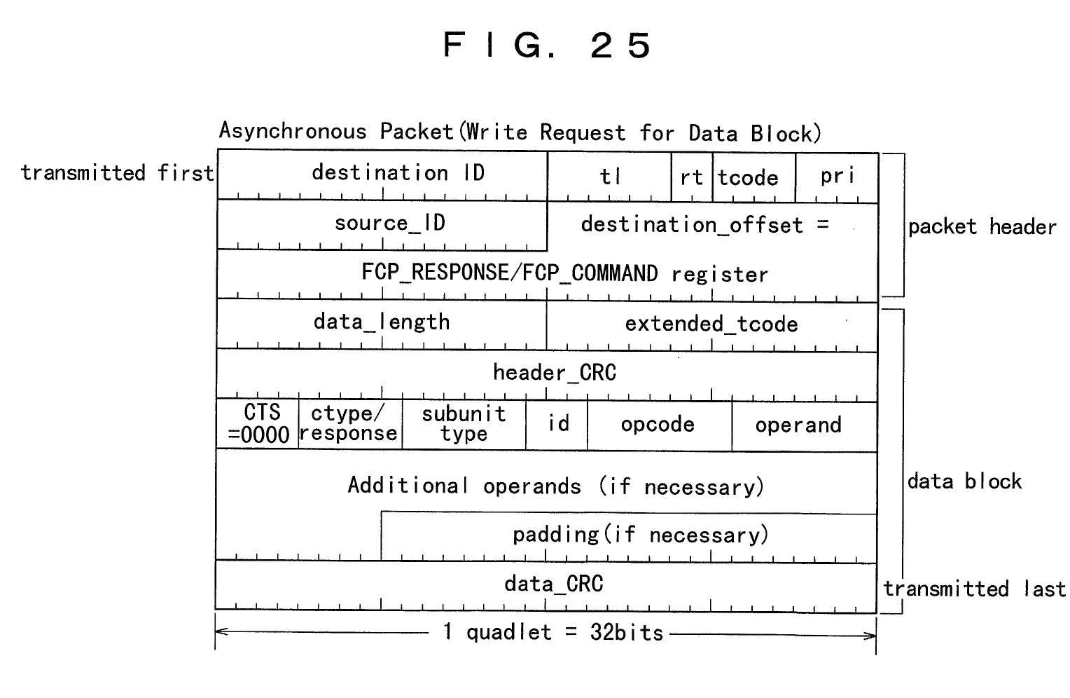

FIG. 24 is a diagram for further illustrating the relationship between a command and a response of the FCP shown in FIG. 23. A node A is connected with a node B via an IEEE 1394 bus. Node A is a controller and node B is a target. Both node A and node B have a command register and a response register, each with 512 bytes. As shown in FIG. 24, the controller writes a command message into the command register 93 in the target to convey a command thereto. Conversely, the target writes a response message into the response register 92 in the controller to convey a response thereto. Between these two messages, control information is exchanged. The type of the command set sent in the FCP is written in the CTS in a data field shown in FIG. 25.

FIG. 25 is a diagram showing the data structure of a packet transmitted in the asynchronous transmission mode of the AV/C command. The AV/C command set is a command set for controlling an AV device where the CTS (i.e., a command set ID)=“0000”. An AV/C command frame and a response frame are exchanged between nodes by use of the FCP described above. In order to prevent burdening the bus and the AV device, the time for responding to the command is limited to 100 ms. As shown in FIG. 25, the asynchronous packet data consists of 32 bits in a horizontal direction (i.e., 1 quadlet). A header of the packet is shown in the upper half of FIG. 25, and a data block is shown in the lower half of FIG. 25. The destination_ID field indicates a destination.

The CTS field shows the command set ID, wherein CTS=“0000” for the AV/C command set. The ctype/response field indicates the function classification of a command when the packet is a command, and indicates the results of command processing when the packet is a response. Commands are roughly classified into four categories as follows: (1) a command for controlling a function from the outside (CONTROL); (2) a command for inquiring as to the state from the outside (STATUS); (3) a command for inquiring as to whether there is support for a control command from the outside (GENERAL INQUIRY for inquiring as to whether there is support for opcode, and SPECIFIC INQUIRY for inquiring as to whether there is support for opcode and operands); and (4) a command for requesting notification to the outside as to a change in state (NOTIFY).

What response is returned depends on the kind of the command. Responses to a CONTROL command are NOT IMPLEMENTED, ACCEPTED, REJECTED and INTERIM. Responses to a STATUS command are NOT IMPLEMENTED, REJECTED, IN TRANSITION and STABLE. Responses to a GENERAL INQUIRY command and a SPECIFIC INQUIRY command are IMPLEMENTED and NOT IMPLEMENTED. Responses to a NOTIFY command are NOT IMPLEMENTED, REJECTED, INTERIM and CHANGED.

The subunit type field specifies the type of the device, as is assigned to identify a tape recorder/player, a tuner, and the like. In order to distinguish each subunit from the others in the case where a plurality of subunits of the same kind exist, the subunit type executes addressing by use of a subunit ID as an identification number. The opcode field shows a command, and the operand field shows a parameter of the command. The additional operands fields are added if necessary. The padding field also is added if necessary. The data cyclic redundancy check (CRC) field is used for an error check in data transmission.

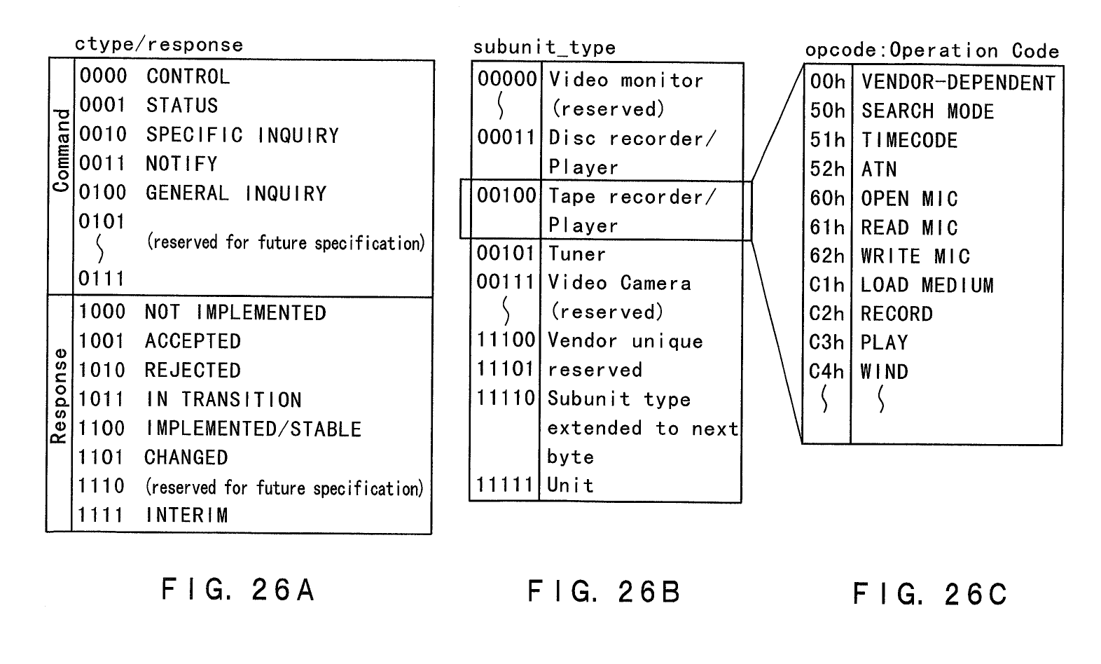

FIGS. 26A to 26C are diagrams showing specific examples of AV/C commands. FIG. 26A shows a specific example of the ctype/response field. The upper half of FIG. 26A shows commands, while the lower half of FIG. 26B shows responses. The value at “0000” is assigned with the CONTROL command, the value at “0001” is assigned with the STATUS command, the value at “0010” is assigned with the SPECIFIC INQUIRY command, the value at “0011” is assigned with the NOTIFY command, and the value at “0100” is assigned with the GENERAL INQUIRY command. The values at “0101” to “0111” are reserved for future specification. In addition, the value at “1000” is assigned with the NOT IMPLEMENTED response, the value at “1001” is assigned with the ACCEPTED response, the value at “1010” is assigned with the REJECTED response, the value at “1011” is assigned with the IN TRANSITION response, the value at “1100” is assigned with the IMPLEMENTED/STABLE response, the value at “1101” is assigned with the CHANGED response, and the value at “1111” is assigned with the INTERIM response. The value at “1110” is reserved for future specification.

FIG. 26B shows a specific example of the subunit type field. The value at “00000” is assigned with a video monitor, the value at “00011” is assigned with a disk recorder/player, the value at “00100” is assigned with a tape recorder/player, the value at “00101” is assigned with a tuner, the value at “00111” is assigned with a video camera, the value at “11100” is assigned with a vendor unique device, the value at “11110” is assigned to indicate that the subunit type is extended to next byte. The value at “11111” is assigned with a unit, and is used for transmitting data to a device itself, for example, for turning on and off the electric power to the device.

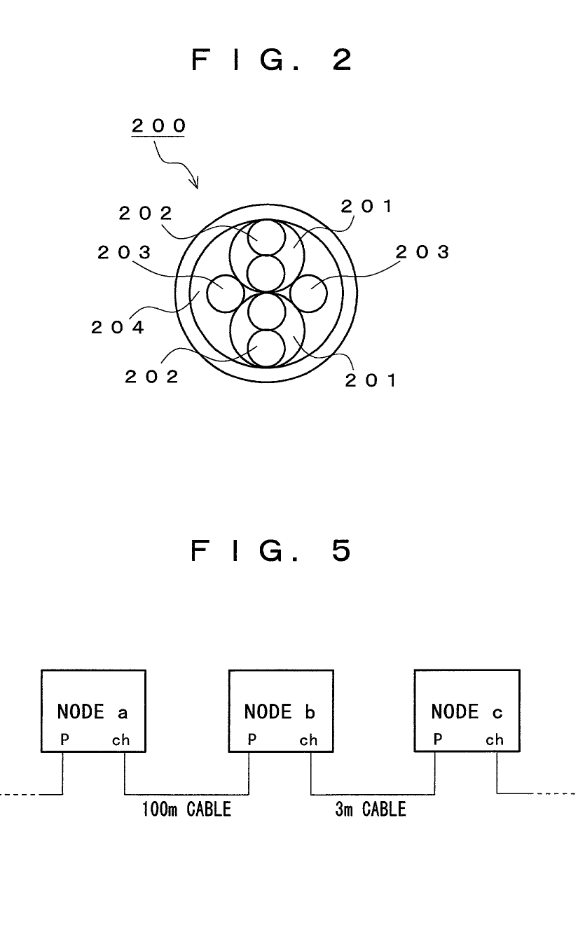

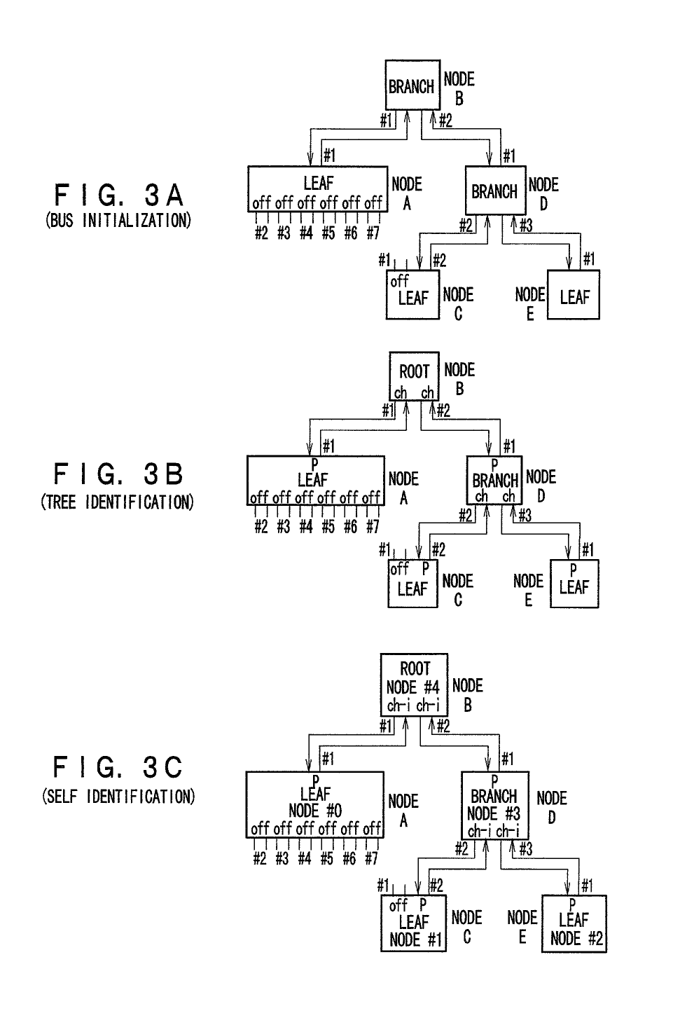

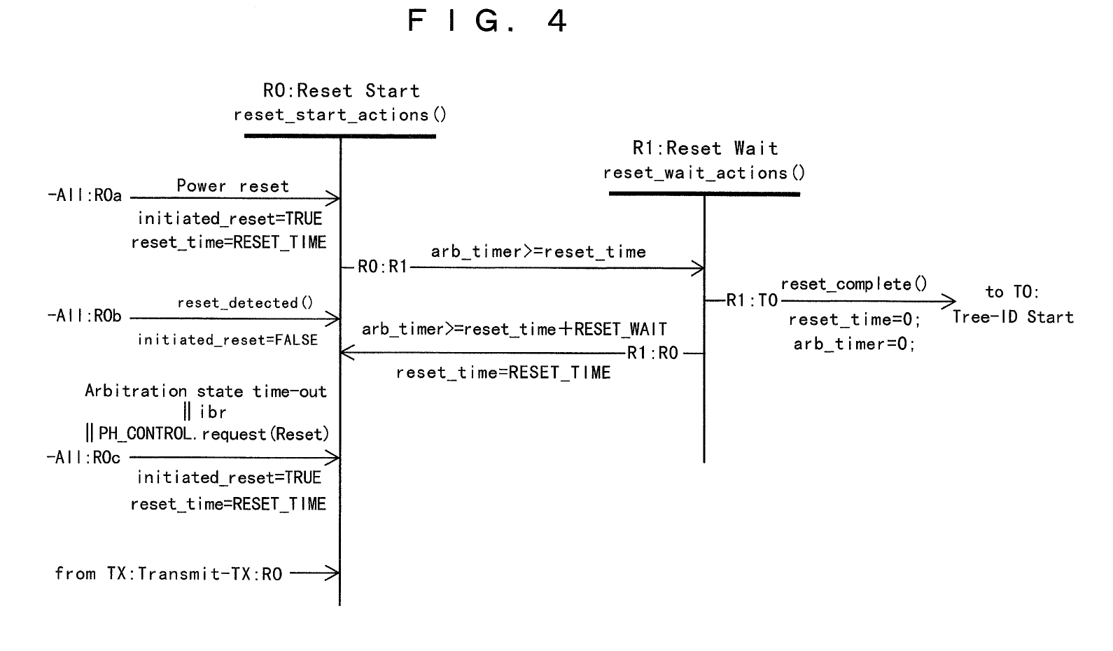

FIG. 26C shows a specific example of the opcode field. Each subunit type has its own opcode table, and FIG. 2 shows the opcode table in the case where the subunit type is a tape recorder/player. In addition, an operand is defined for each opcode. In the example of FIG. 26C, “00h” is assigned with VENDOR-DEPENDENT, “50h” is assigned with SEACH MODE, “51h” is assigned with TIMECODE, “52h” is assigned with ATN, “60h” is assigned with OPEN MIC, “61h” is assigned with READ MIC, “62h” is assigned with WRITE MIC, “C1h” is assigned with LOAD MEDIUM, “C2h” is assigned with RECORD, “C3h” is assigned with PLAY, and “C4h” is assigned with WIND.

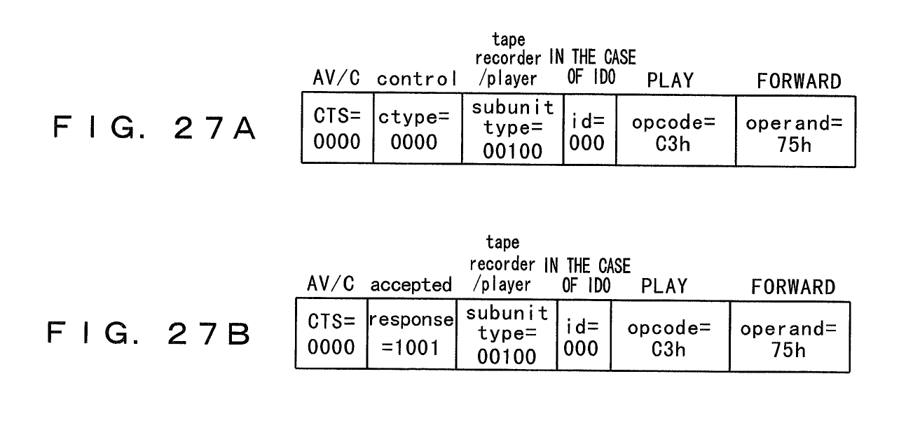

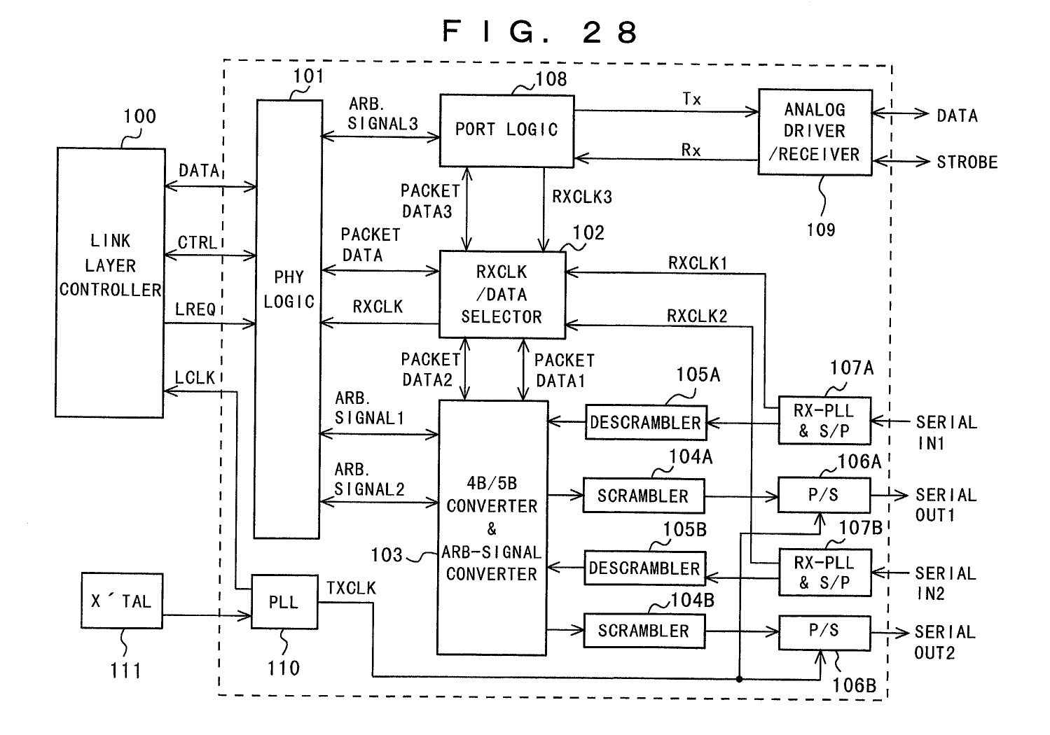

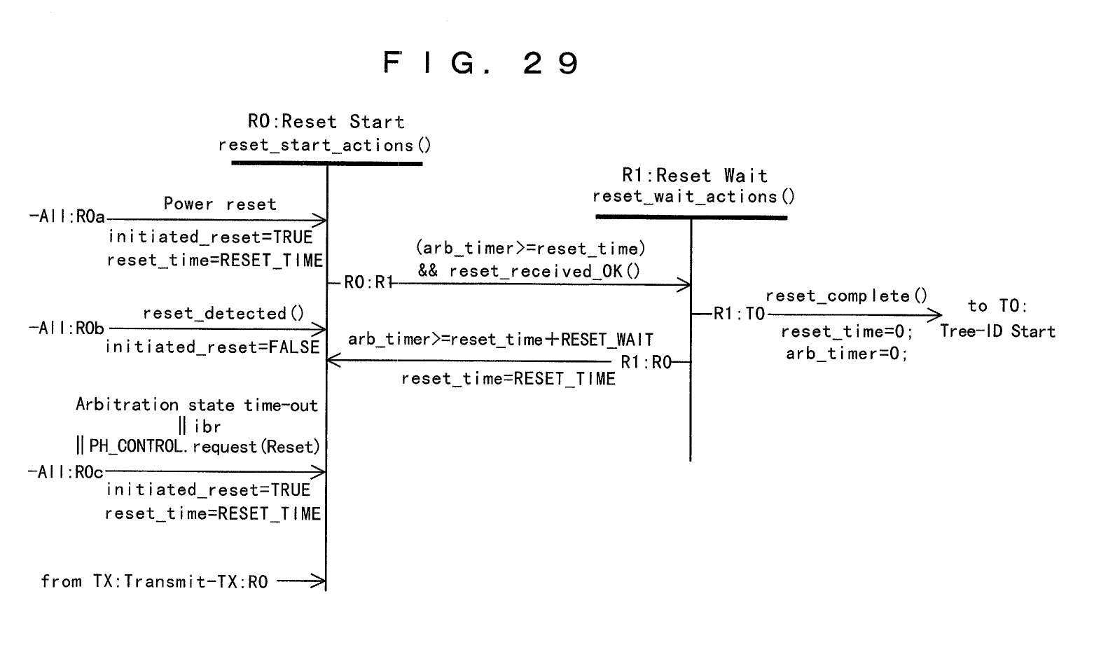

FIGS. 27A and 27B show specific examples of an AV/C command and a response. For example, when an instruction for executing reproduction is provided to a reproducing device as a target (consumer), the controller sends a command such as shown in FIG. 27A to the target. Since this command uses the AV/C command set, the CTS is at “0000”. Since the command for controlling the device from the outside (CONTROL) is used for the ctype, the ctype is at “0000” (see FIG. 26A). Since the subunit type is a tape recorder/player, the subunit type is at “00100” (see FIG. 26B). The id shows the case of IDO, wherein the id is at “000.” The opcode is at “C3h” which means play (reproduce) (see FIG. 26C). The operand is at “75h” which means FORWARD. When reproduced, the target returns a response to the controller, such as shown in FIG. 27B. In the example shown in FIG. 27B, “accepted”, meaning that the data has been received, is part of the response and, therefore, the response is at “1001” (see FIG. 26A). Except for the response, the other configurations of FIG. 27B are basically the same as in FIG. 27A and, therefore, their descriptions will be omitted.

FIG. 28 shows an interface unit for digital serial data which constitutes a physical layer in conformity with the IEEE 1394 standard described above. The interface unit includes a physical layer logical block (PHY LOGIC) 101, a selector block (RXCLK/DATA SELECTOR) 102, a conversion block (4B/5B CONVERTER & ARB-SIGNAL CONVERTER) 103, scramble blocks (SCRAMBLER) 104A and 104B, descramble blocks (DESCRAMBLER) 105A and 105B, transmission blocks (P/S) 106A and 106B, receiving blocks (RX-PLL & S/P) 107A and 107B, a port logical block (PORT LOGIC) 108, an analog driver/receiver (ANALOG DRIVER/RECEIVER) 109, and a clock generation block (PLL) 110.

The physical layer logical block 101 executes input-output (I/O) control and arbitration control between the physical layer and the link layer defined by the IEEE 1394 high performance serial bus standard (i.e., the IEEE 1394 standard). The physical layer logical block 101 is connected to the link layer controller 100 in conformity with the IEEE 1394 standard, and also is connected to the selector block 102, the conversion block 103, and the port logical block 108.

The I/O between the physical layer and the link layer through the physical layer logical block 101 meets the requirements of the IEEE 1394 standard. Communication between the link layer and the physical layer is executed by use of a data signal DATA and a control signal CTRL, and, in addition, a link request signal LREQ is input into the physical layer logical block 101 as a request for data transmission from the link layer to the physical layer.

The physical layer logical block 101 incorporates an arbitration controller therein. The arbitration controller is used to control data transmission and receipt executed between the arbitration process and the bus. When there is a request to transmit a packet, the arbitration controller begins arbitration after an appropriate time gap has elapsed. The time gap varies depending on the kind of arbitration. The physical layer logical block 101 sends the PACKET DATA data received from the link layer to the selector block 102, and sends the arbitration request received from the link layer to the conversion block 103 and the port logical block 108.

The selector block 102 selects one pair from: the PACKET DATA 1 data received via the conversion block 103, and the receive clock RXCLK1 thereof; the PACKET DATA 2 data received via the conversion block 103, and the receive clock RXCLK2 thereof; and the PACKET DATA 3 data received via the port logical block 108, and the receive clock RXCLK3 thereof. The selector block 102 is connected to the physical layer logical block 101, the conversion block 103, the receive blocks 107A, 107B, and the port logical block 108.

When transmitting data, the selector block 102 sends the PACKET DATA data, which has been received from the physical layer logical block 101, to the conversion block 103 and the port logical block 108. In this manner, transmission data is sent to all the transmission ports. Also, when receiving data, the selector block 102 selects one pair from: the PACKET DATA 1 data and the receive clock RXCLK1 thereof; the PACKET DATA 2 data and the receive clock RXCLK 2 thereof; and the PACKET DATA 3 data and the receive clock RXCLK 3 thereof, which have been received via the conversion block 103 or the port logical block 108. Then, the selector block 102 sends the selected pair, for example, the PACKET DATA 1 data and the receive clock RXCLK 1 thereof, to the physical layer logical block 101.

The packet data selected by the selector block 102, for example, the PACKET DATA 1 data received from the conversion block 103, is written into a FIFO memory within the physical layer logical block 101 by use of its receive clock RXCLK1. The packet data written into the FIFO memory is read by the system clock LCLK provided from the clock generation block 110.

The conversion block 103 serves as a converter for 4 bit/5 bit data conversion, and also serves as an arbitration signal converter means for assigning to the arbitration signal a 5 bit symbol other than the 5 bit symbol assigned to the data in the 4 bit/5 bit data conversion. When the arbitration is executed, the conversion block 103 converts the arbitration signals ARB. SIGNALL and ARB. SIGNAL2, which have been sent from the physical layer logical block 101, into 5 bit symbols assigned to the respective arbitration signals, as shown in Table 6 below. The conversion block 103 then sends the 5 bit symbols to each of the scramble blocks 104A and 104B. Simultaneously, the conversion block 103 converts the 5 bit arbitration signals which have been sent from each of the descramble blocks 105A and 105B into 4 bit signals, and sends the resultant 4 bit signals to the physical layer logical block 101.

Specifically, when transmitting data, the conversion block 103 assigns to the arbitration signals the 5 bit symbols as shown in Table 6, and sends the resultant 5 bit symbols to each of the scramble blocks 104A, 104B. When receiving data, the conversion block 103 assigns the receive symbols and transmission symbols together to the arbitration states.

TABLE 6

| Transmission | |
|---|---|
| arbitration signal | Transmission symbol |
| IDLE | 11111 |
| TX_REQUEST | 00100 |
| TX_GRANT | |
| TX_PARENT NOTIFY | 00101 |
| TX_DATA_PREFIX | 11000_10001 |
| TX_CHILD_NOTIFY | 00111 |
| TX_IDENT_DONE | |
| TX_DATA_END | 01101 |
| BUS_RESET | 00000_11111 |

TABLE 7

| | Transmission | Receive arbitration |
|---|---|---|
| Received symbol | symbol | state |
| 11111 | 11111 | IDLE |
| 00100 | 11111 | RX_SELF_IDGRANT |
| | | RX_REQUEST |
| 00101 | 11111 | RX_PARENT_NOTIFY |
| 11111 | 00100 | RX_REQUEST_CANCEL |
| 11000_10001 | | RX_DATA_PREFIX |
| 00111 | 11111 | RX_IDENT_DONE |
| 01101 | 11111 | RX_DATA_END |
| 00111 | 00101 | RX_PARENT_HANDSHAKE |
| 00101 | 00101 | RX_ROOT_CONTENTION |
| 00100 | 00100 | RX_GRANT |
| 11111 | 00111 | RX_CHILD_HANDSHAKE |
| 00000_1111 | | BUS_RESET |

When transmitting packet data, the conversion block 103 converts the PACKET DATA 1 data and PACKET DATA 2 data, which are 4 bit signals sent via the selector block 102, into 5 bit signals by assigning the values shown in Table 8. The conversion block 103 then sends the resultant 5 bit signals to each of the scramble blocks 104A and 104B. Simultaneously, the conversion block 103 converts the received packet data, which are 5 bit signals sent from each of the descramble blocks 5A and 5B, into 4 bit signals, and then sends the resultant 4 bit signals to the selector block 102.

TABLE 8

| 4 bit signal | 5 bit signal |
|---|---|
| 0000 | 11110 |
| 0001 | 01001 |
| 0010 | 10100 |
| 0011 | 10101 |
| 0100 | 01010 |
| 0101 | 01011 |
| 0110 | 01110 |
| 0111 | 01111 |
| 1000 | 10010 |
| 1001 | 10011 |
| 1010 | 10110 |
| 1011 | 10111 |
| 1100 | 11010 |
| 1101 | 11011 |
| 1110 | 11100 |
| 1111 | 11101 |

In the 4 bit/5 bit conversion in the conversion block 103 described above, as shown in Table 8, 5 bit signals each including much clock information are assigned to the PACKET DATA 1 and PACKET DATA 2 data. This enables the PACKET DATA 1 and PACKET DATA 2 data receiver to reliably produce receive clock signals RXCLK1, RXCLK2 thereof from the receive signals by use of the clock generation block 110.

In addition, the 5 bit signal “11111” which includes the largest amount of clock information is assigned to the idle state in the arbitration defined by the IEEE 1394 standard. In this manner, the clock generation block 110 at the receiver side is kept locked even in the idle state in the arbitration, thereby reliably executing the arbitration.

Each of the scramble blocks 104A and 104B scrambles the 5 bit signal sent from the conversion block 103 at the time of packet data transmission by use of a shift register. The scrambling prevents the occurrence of peaks in the frequency, thereby reducing unnecessary radiation which may be caused by the 5 bit transmission signal. The 5 bit transmission signals which have been subjected to scrambling by the scramble blocks 104A and 104B are sent to the transmission blocks 106A and 106B, respectively.

Each of the descramble blocks 105A and 105B descrambles the 5 bit signal sent from each of the receive blocks 107A and 107B, wherein the descrambling corresponds to the scrambling executed by the scramble blocks 104A and 104B. As a result of the descrambling, the 5 bit receive signal is released from the scrambled state. The 5 bit receive signals which have been subjected to descrambling are sent to the conversion block 103. The scramble blocks 104A and 104B and the descramble blocks 105A and 105B are so designed that each operation thereof can be turned on and off.

Each of the transmission blocks 106A and 106B converts the 5 bit transmission signal which has been scrambled by the scramble blocks 104A and 104B from parallel data to serial data, and further converts the 5 bit transmission signal from NRZ data to NRZI data and transmits the resultant signals.

Also, each of the receive blocks 107A and 107B converts the receive signal from NRZI data to NRZ data, and further converts the receive signal from serial data to parallel data, and sends the resultant 5 bit receive signal to the descramble blocks 105A and 105B. Each of the receive blocks 107A and 107B produces receive clocks RXCLK1, RXCLK2 from the received data by use of the clock generation block 110, and sends them to the selector block 102.

The port logical block 108 transmits and receives an arbitration signal ARB. SIGNAL 3 and PACKET DATA 3 data which conform to the physical layer defined by the IEEE 1394 standard. The port logical block 108 produces a receive clock RXCLK3 from the data which is sent thereto via the analog driver/receiver 109, and a strobe signal thereof. In addition, the port logical block 108 receives the arbitration signal ARB. SIGNAL 3 from the physical layer logical block 101 when arbitration is executed.

When transmitting data, the port logical block 108 converts the PACKET DATA 3 data, which has been sent from the physical layer logical block 101 via the selector block 102, into serial data by use of the transmission clock TXCLK provided from the clock generation block 110. Then, the port logical block 108 sends the resultant serial data via the analog driver/receiver 109.

When receiving data, the port logical block 108 sends the PACKET DATA 3 data, which has been received via the analog driver/receiver 109, to the physical layer logical block 101 via the selector block 102, together with the receive clock RXCLK3 thereof. If the port logical block 108 is selected by the selector block 102, the PACKET DATA 3 data is written into the FIFO memory within the physical layer logical block 101 by use of the receive clock RXCLK3 thereof.

The clock generation block 110 produces a 49.152 MHz system clock, a 98.304 MHz transmission clock, and a 122.88 MHz transmission clock from the 24.576 MHz clock provided from a quartz oscillator 111.

The interface unit for digital serial data in the aforementioned structure is provided with a conversion block 103 for performing 4 bit/5 bit conversion of the arbitration signals ARB. SIGNAL 1 and ARB. SIGNAL 2, and the PACKET DATA 1 and PACKET DATA 2 data. The conversion block 103 allows the transmission and receipt of the arbitration signals ARB. SIGNAL 1 and ARB. SIGNAL 2 and the PACKET DATA 1 and PACKET DATA 2 data as 5 bit code data via the transmission blocks 106A, 106B, and the receive blocks 107A, 107B, respectively. The interface unit structured in this manner can execute long distance transmission by employing an optical fiber or an unshielded twisted pair (UTP) as a transmission cable.

When the conversion block 103 in the interface unit structured as described above converts the 5 bit receive symbol and the 5 bit transmission symbol together into arbitration signals, the conversion block 103 prevents the signals ARB. SIGNAL 1 and ARB. SIGNAL 2 from being influenced by the bus reset signal which is to be transmitted from its own node (see the section “BUS RESET” in Table 7).

When an optical fiber or an unshielded twisted pair is used as a transmission cable, duplex transmission is possible. In this case, the transmission of an arbitration signal and the receipt of an arbitration signal, other than a bus reset signal, may be converted together, whereas the bus reset signal may be converted from the receive signal only. In this manner, the physical layer logical block 101 can acknowledge only bus reset signals sent from a connected partner.

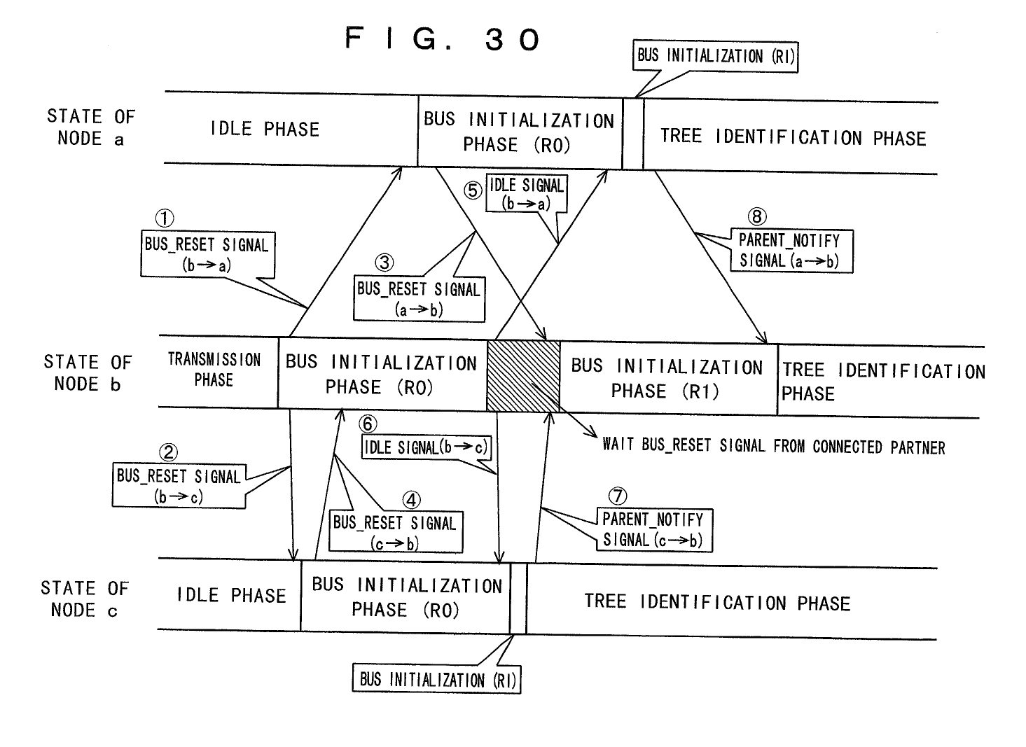

The operation at the bus initialization phase is performed in the physical layer logical block 101. In this embodiment, the operation at the bus initialization phase is performed in accordance with the transition drawing shown in FIG. 29. In the transition drawing shown in FIG. 29, a condition in which a bus reset signal has been received by all the ports in an active state capable of duplex transmission (i.e., ports designed for long distance communication) is added to the transition condition of R0:R1. This arrangement prevents a problem in which an IDLE signal is received in a reset wait state from a partner connected by use of a long cable, resulting in an erroneous transfer to a tree identification phase where the bus reset signal is received from the connected partner at the tree identification phase so as to return again to a bus reset state (i.e., the R0 state) at the bus initialization phase.

The transition condition of R0:R1 after the above condition is added is as follows:

(arb_timer>=reset_time)&&reset_received_ok( ).

By employing the transition condition such as described above, the bus reset signal is sent in the R0 state for a specified and predetermined period of time (at a short bus reset, 1.26 ƒÊm to 1.40 ƒÊm) to the connected partner. When it is acknowledged that the specified time has elapsed and also that the bus reset signal has been received from all the connected partners, the state is transferred to the R1 state (i.e., a reset wait state).

In this arrangement, there is no fear that an IDLE signal received in a reset wait state from a partner connected using a long cable will result in an erroneous transfer to a tree identification phase, and the bus reset signal will be received from the connected partner at the tree identification phase so as to return again to a bus reset state (i.e., the R0 state) at the bus initialization phase. As a result, short bus reset can be operated normally even in the case where the electronic equipment is connected with the partners by use of a long cable.

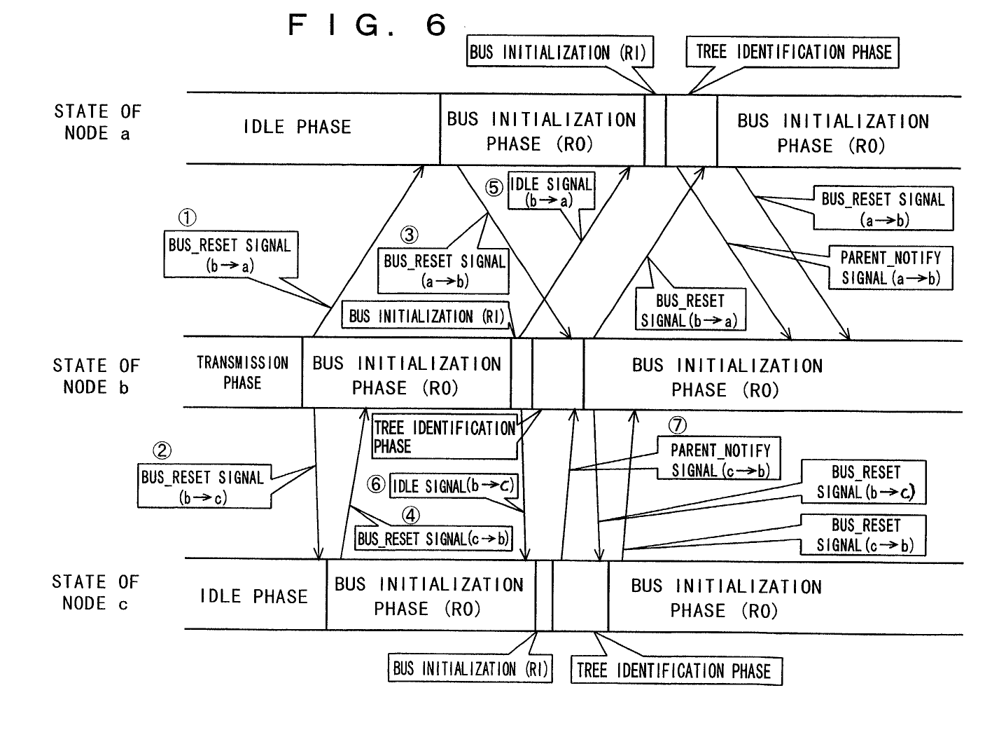

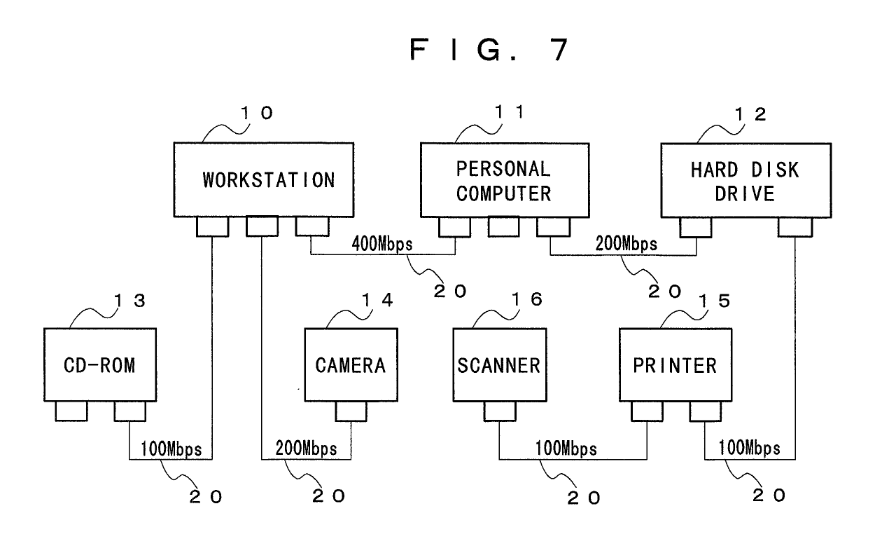

Hereinafter, the operation of short bus reset in a network constituted by nodes a, b, and c, as shown in FIG. 5, will be described with reference to FIG. 30. FIG. 30 shows the operations of nodes a, b, and c with the elapse of time in a simplified manner.

When any event causing short bus reset occurs in node b, node b transfers its state to the R0 state in accordance with the transition drawing shown in FIG. 29. Node b sends a bus reset signal to nodes a and c for a predetermined period of time (ranging from 1.26 ƒÊm at the shortest to 1.40 ƒÊm at the longest) (see Steps 1 and 2 in FIG. 30). Upon receiving the bus reset signal from node b, nodes a and c themselves also start to send bus reset signals (see Steps 3 and 4 in FIG. 30).

After that, node b waits until it receives a bus reset signal from node a, while it keeps on sending an IDLE signal to nodes a and c (see Steps 5 and 6 in FIG. 30). At this time, node b receives a PARENT_NOTIFY signal (see Step 7 in FIG. 30) from node c. After that, when node b receives a bus reset signal from node a, node b transfers its state to the R1 state where node b waits to receive an IDLE signal or a PARENT_NOTIFY signal from node a. Node a, upon receiving the IDLE signal from node b, transfers its state to a tree identification phase where it sends a PARENT_NOTIFY signal to node b (see Step 8 in FIG. 30). Node b receives the PARENT_NOTIFY signal from node a and transfers its state to a tree identification phase.

In this manner, the operation of the bus initialization phase is conducted in accordance with the transition drawing shown in FIG. 29. In this manner, it is possible to allow short bus reset to operate normally in the network shown in FIG. 5.

As described above, in an embodiment of the present invention, each node transfers its state to the R1 state after it acknowledges receipt of the bus reset signals from all the connected partners. There is no state in which the node receives an IDLE signal after it transfers its state to the R1 state and before it receives the bus reset signal from all the connected partners. This arrangement prevents a problem in which the node erroneously transfers its state to the tree identification phase to return again to the R0 state where it conducts a normal bus reset operation. In this manner, short bus reset can be operated normally even when long distance transmission is conducted by use of an optical fiber and UTP.

In the above embodiment, a transmission and receive system in 5 bit coding format has been described. The present invention is not limited to a specific system by its coding method and kind of cable, but any other system employing other coding methods and other kinds of cables may be employed in the present invention as far as duplex communication is possible.

According to the present invention, at a bus initialization phase, a bus reset signal is sent to all the connected partners for a specified period of time in the reset start state, and when it is acknowledged that bus reset signals have been received from all the connected partners and a specified period of time has elapsed, the state is transferred to the reset wait state, thereby enabling the short bus reset to operate normally, even in the case where a long cable is used for connection with the connected partners.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. Electronic equipment, comprising
a bus;
an interface unit for digital serial data connected to said bus, said interface unit having a physical layer in conformity with the IEEE 1394 standard;
at least one partner connected to said bus, each said connected partner having a physical layer which conforms to the IEEE 1394 standard; and
a processor connected to said interface unit;
said interface unit including
a transmitter for transmitting an arbitration signal to each said connected partner, and a receiver for receiving an arbitration signal from each said connected partner,
wherein, in a bus initialization phase, a bus reset signal is sent to each said connected partner for a predetermined period of time in a reset start state of said interface unit, and when it is acknowledged that a specified period of time has elapsed and bus reset signals have been received from each said connected partner, said interface unit is transferred to a reset wait state.

2. Electronic equipment according to claim 1,
wherein said interface unit further includes a decoder for decoding a receive arbitration state from said transmitted arbitration signals and said received arbitration signals, and
said decoder performs bus reset and decoding for said receive arbitration state without depending on said transmitted arbitration signals when said decoder receives said bus reset signal from each said connected partner as said arbitration signal.

3. Electronic equipment according to claim 1, wherein said interface unit conducts duplex transmission with each said connected partner.

4. A method for bus initialization in an interface unit for digital serial data having a physical layer in conformity with the IEEE 1394 standard, the interface unit being connected by a bus to at least one partner having a physical layer which conforms to the IEEE 1394 standard, the method comprising:
transmitting a bus reset signal to each connected partner for a predetermined period of time in a reset start state of the interface unit; and
transferring the state of the interface unit to a reset wait state when it is acknowledged that bus reset signals have been received from each connected partner and a specified period of time has elapsed.

5. The method according to claim 4, further comprising:
decoding a receive arbitration state from an arbitration signal transmitted to each connected partner and an arbitration signal received from each connected partner,
wherein, in the decoding step, bus reset and decoding for the receive arbitration state are performed without depending on the transmitted arbitration signal when a bus reset signal is received from each connected partner as the arbitration signal.
